(19) United States
(12) Patent Application Publication
(10) Pub. No.: US 2023/0077774 A1
(43) Pub. Date: Mar. 16, 2023

(54) Effectiveness Analysis For Performance Regression Bisection

(71) Applicant: SAP SE, Walldorf (DE)

(72) Inventor: Frolin Ocariza, Richmond (CA)

(21) Appl. No.: 17/534,215

(22) Filed: Nov. 23, 2021

Related U.S. Application Data
(60) Provisional application No. 63/242,463, filed on Sep. 9, 2021.

(51) Int. Cl. G06F 8/71; G06F 17/18

(52) U.S. Cl. CPC G06F 8/71; G06F 17/18

(57) ABSTRACT

Performance regressions can have a drastic impact on the usability of a software application. The crucial task of localizing such regressions can be achieved using bisection, which attempts to find the bug-introducing commit using binary search. However, a bisection is not always accurate or effective. An effectiveness measure for performing a bisection may be determined based on a first probability that a shift in distribution of performance measures of a plurality of versions of the software occurs at a particular version of the software given that a bisection would identify that particular version of the software as having the performance regression. Also, a baseline value that maximizes the effectiveness measure may be determined. Accordingly, bisection may be used if it would be effective and it may be performed using an effective baseline value.

### BACKGROUND

The present disclosure pertains to performance regressions and in particular to the effectiveness of performing a performance regression bisection.

Software applications may be developed using version control techniques that manage and document changes to the application over time. New or different versions of the software application may be stored at a repository of a version control system using a commit operation such that others can retrieve that version. A version of software committed to the repository may be called a “commit.” In software development, changes to the software may be committed to a repository numerous times before a performance test is performed on the current version of the software. If the performance test shows that the performance of the application has regressed from a previous performance test, then the current version of one of the intervening commits may have introduced the software performance regression.

Performance regressions can have a drastic impact on the usability of a software application. Localizing such regressions can be achieved using bisection, which attempts to find the bug-introducing commit using binary search. The bisection technique conducts performance tests on a certain version of the software and compares the performance for that version to a baseline performance. This comparison is used to conduct the search. For software performance regressions, the bisection approach may be heuristical, and therefore may not guarantee correctness. Performing a bisection for software performance regression may also be time-consuming because numerous performance tests may need to be conducted for a single version of the software to achieve statistical significance and numerous versions of the software may need to be tested when performing the bisection search. Furthermore, selection of the baseline used in the performance measure comparison is also important to the accuracy of the bisection.

Accordingly, there is a need for improved techniques for analyzing the effectiveness of a bisection for performance regressions and for selection of a baseline for the bisection. The present disclosure addresses these issues and others, as further described below.

### SUMMARY

One embodiment provides a computer system comprising one or more processors and one or more machine-readable medium coupled to the one or more processors. The one or more machine-readable medium storing computer program code comprising sets of instructions. The sets of instructions executable by the one or more processors to compare a performance measure for a later version of software to a performance measure of an earlier version of the software where a difference between the performance measure for the later version and the performance measure for the earlier version indicates a performance regression of the software. The sets of instructions further executable by the one or more processors to determine an effectiveness measure for performing a bisection based on a first probability that a shift in distribution of performance measures of a plurality of versions of the software occurs at a particular version of the software given that a bisection would identify that particular version of the software as having the performance regression. The sets of instructions further executable by the one or more processors to determine a baseline value that maximizes the effectiveness measure by calculating a plurality of effectiveness measures over a set of baseline values. The sets of instructions further executable by the one or more processors to perform the bisection using the most effective baseline value if the effectiveness measure is above a threshold.

Another embodiment provides one or more non-transitory computer-readable medium storing computer program code. The computer program code comprises sets of instructions to compare a performance measure for a later version of software to a performance measure of an earlier version of the software where a difference between the performance measure for the later version and the performance measure for the earlier version indicating a performance regression of the software. The computer program code further comprises sets of instructions to determine an effectiveness measure for performing a bisection based on a first probability that a shift in distribution of performance measures of a plurality of versions of the software occurs at a particular version of the software given that a bisection would identify that particular version of the software as having the performance regression. The computer program code comprises sets of instructions to determine a baseline value that maximizes the effectiveness measure by calculating a plurality of effectiveness measures over a set of baseline values. The computer program code comprises sets of instructions to perform the bisection using the most effective baseline value if the effectiveness measure is above a threshold.

Another embodiment provides a computer-implemented method. The method includes comparing a performance measure for a later version of software to a performance measure of an earlier version of the software where a difference between the performance measure for the later version and the performance measure for the earlier version indicating a performance regression of the software. The method further includes determining an effectiveness measure for performing a bisection based on a first probability that a shift in distribution of performance measures of a plurality of versions of the software occurs at a particular version of the software given that a bisection would identify that particular version of the software as having the performance regression. The method further includes determining a baseline value that maximizes the effectiveness measure by calculating a plurality of effectiveness measures over a set of baseline values. The method further includes performing the bisection using the most effective baseline value if the effectiveness measure is above a threshold.

### BRIEF DESCRIPTION OF THE DRAWINGS

FIG. 1 shows a diagram of a software test system and a version control system, according to an embodiment.

FIG. 2 shows a flowchart of a method for determining a bisection effectiveness measure, according to an embodiment.

FIG. 3 shows a diagram of a software performance regression localization problem, according to an embodiment.

FIG. 4 shows a diagram of a performance regression, according to an embodiment.

FIG. 5 shows a diagram of an exemplary bisection, according to an embodiment.

FIG. 6 shows a diagram continuing the exemplary bisection from FIG. 5, according to an embodiment.

FIG. 7 shows a diagram continuing the exemplary bisection from FIG. 6, according to an embodiment.

FIG. 8 shows a diagram of the result of the exemplary bisection, according to an embodiment.

FIG. 9 shows a diagram modeling software commits for determination of an effectiveness measure, according to an embodiment.

FIG. 10 shows a diagram modeling software commits for determination of an effectiveness measure that represents the distributions as X and Y, according to an embodiment.

FIG. 11 shows a diagram of a bisection technique that compares the baseline to X and Y, according to an embodiment.

FIG. 12 shows a diagram of the bisection of FIG. 11 where paths are pruned, according to an embodiment.

FIG. 13 shows a diagram of hardware of a special purpose computing system for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It is evident, based on the language of the different claims, that the claimed subject matter may include some or all of the features in these examples, alone or in combination, and may further include modifications and equivalents of the features and techniques described herein. While certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. Furthermore, the terms “first,” “second,” “third,” “fourth,” etc., used herein do not necessarily indicate an ordering or sequence unless indicated. These terms may merely be used for differentiation between different objects or elements without specifying an order.

As mentioned above, software applications may be developed using version control techniques that manage and document changes to the application over time. New or different versions of the software application may be stored at a repository of a version control system using a commit operation such that others can retrieve that version. A version of software committed to the repository may be called a “commit.” In software development, changes to the software may be committed to a repository numerous times before a performance test is performed on the current version of the software. If the performance test shows that the performance of the application has regressed from a previous performance test, then the current version of one of the intervening commits may have introduced the software performance regression.

A software performance regression (also referred to as “performance regression” herein) may occur when, after applying a series of code changes, the response time or resource usage metrics of an application degrades. Software performance regressions may have a drastic impact on the usability of a software application. Localizing such regressions can be achieved using bisection, which attempts to find the bug-introducing commit using binary search. The search ranges from the last commit observed to not include the regression (the good commit) to the first commit observed to include the regression (the bad commit), and continues recursively until the first commit to manifest the regression (the root cause or the bug-introducing commit) is found. The bisection technique conducts performance tests on a certain version of the software and compares the performance for that version to a baseline performance and this comparison is used to conduct the search. For software performance regressions, the bisection approach may be heuristical, and therefore may not guarantee correctness. Unlike functional regressions, the metrics used to assess if a particular commit has a performance regression may not be binary or monotonic, due to variance in the performance metrics. Nonetheless, bisection can still be applied to performance regression localization; in particular, the performance of a particular commit can still be measured and thereby compared to a baseline number. For instance, if logging on to a web application used to take around 2 seconds, but now takes around 10 seconds after a performance regression has been introduced, a commit can be tagged as “buggy” if its logon response time exceeds a selected baseline value, say, 2 seconds.

Performing a bisection for software performance regression may be time-consuming because numerous performance tests may need to be conducted for a single version of the software (i.e., a single commit) to achieve statistical significance. Furthermore, numerous versions of the software may need to be tested when performing the bisection. Selection of the baseline used in the performance measure comparison may be important to the accuracy of the bisection since the performance may vary due to other external factors beyond the software code (e.g., network performance, user input delays, available processing and memory resources, the response times of other computer systems, etc.). Given the possible variance in performance numbers, the bisection for a performance regression may be heuristical. Due to its probabilistic nature, it would be advantageous to quantify the likelihood that bisection outputs the correct commit and to determine the conditions under which this likelihood is high. Practitioners may then use these findings to determine whether bisection is a suitable solution when localizing specific performance regressions, and if so, determine the parameters (e.g., baseline) with which to configure the bisection.

This disclosure presents the formulation of an effectiveness measure that can be used to quantify the probability of a successful bisection. The effectiveness measure may be used to quantify the effectiveness of any bisection that involves performance regressions.

An analysis of the main input properties of a performance regression bisection that contribute to its effectiveness (i.e., “contributing properties”) shows that the effectiveness of a bisection on performance regressions is impacted primarily by the choice of baseline value and the characteristics of the probabilistic distributions describing the good commit (e.g., the earlier tested commit that passed the performance test) and the bad commit (e.g., the recently tested commit that failed the performance test). To a lesser degree, the length of the commit range is also shown to impact the effectiveness. The effectiveness may also be sensitive to the transition index—i.e., the suspected location of the bug-introducing commit—which implies that it would be useful to measure the effectiveness of a bisection both before and after it executes.

This disclosure goes into greater detail on what bisection is in the context of localizing software regressions in general, and describes the benefits of using it to localize performance regressions in particular. It also describes the challenges involved with bisecting such performance regressions; these challenges provide the primary motivation for this study. First, software testing systems and version control systems which are involved in testing for performance regressions are described.

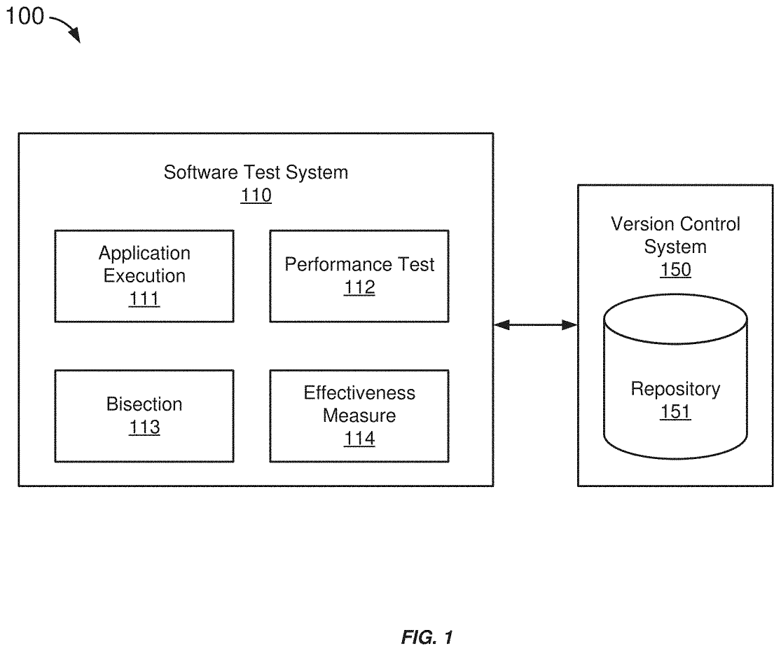

FIG. 1 shows a diagram 100 of a software test system 110 and a version control system 150, according to an embodiment. The software test system 110 may be a system of one or more computers (e.g., server computers). The software test system 110 includes an application execution software module 111, a performance test software module 112, a bisection software module 113, and an effectiveness measure 114 software module. The software modules 111, 112, 113, and 114 may comprise computer program code for performing the corresponding functionality. The software test system 110 may include one or more computer processing units or other processors that can access a memory of the test system 110 storing the computer program code and executing the code to perform the corresponding functionality.

The software test system 110 may be used to test software applications. It may also be used to develop the software applications. When software applications are developed, changes to the source code corresponding to difference versions of the software may be “committed” to a repository database 151 (“repository”) of a version control system 150. Each difference version of the software committed to the repository 151 may be referred to as a “commit” herein. In some embodiments, the version control system 150 may be a database server in communication with the software test system 110 over a network (e.g., the Internet or an intranet). In some embodiments, the version control system 150 may be part of the software test system 110.

The application execution software module 111 may be configured to retrieve a particular commit stored in the repository 151 and execute that version of the software application. Execution of the application allows for it to be tested. The application undergo a functional test (e.g., determining whether certain functions or actions of the software perform correctly) and/or regression testing (e.g., determining whether the software executes operations within a predetermined time).

The performance test software module 112 may be configured to perform functional tests and/or regression tests of the software application. With regression testing, the performance test software module 112 may be configured to run performance tests of a particular operation or function. For example, a regression test may measure application start time, function execution time, delay in processing, memory usage, processor utilization, etc. The performance may be measured numerous times in order to obtain a statistically significant result across the set of tests. Statistics (e.g., median or mean) from the performance test results may be computed and compared to a predetermined baseline value. The baseline value may be set based on previous software performance tests on a version of the software that has been deemed to have adequate performance, for example. For example, the baseline may be set to be equal to the past performance (e.g., a past statistical value of the performance) or it may be set at a certain level above (or below) the past performance (e.g., to account for variation in performance), depending on whether lower or higher performance numbers indicate better performance.

The bisection software module 113 may be configured to perform a bisection to determine (localize) a performance regression in a set of commits (e.g., across an array representing the commits). The bisection 113 performs a search for the commit that introduced the software performance regression using performance results determined by the performance test module 112. The course of the search may be determined by comparing performance measures against a baseline value. Further description of a bisection and examples are provided below.

The effectiveness measure software module 114 may be configured to determine an effectiveness measure indicating how effective it would be to perform a bisection. The effectiveness measure module 114 may also be configured to determine the effectiveness measure for one or more different baseline values and also determine a comparatively more effective baseline value to use when performing the bisection. The effectiveness measure and its derivation are further described herein.

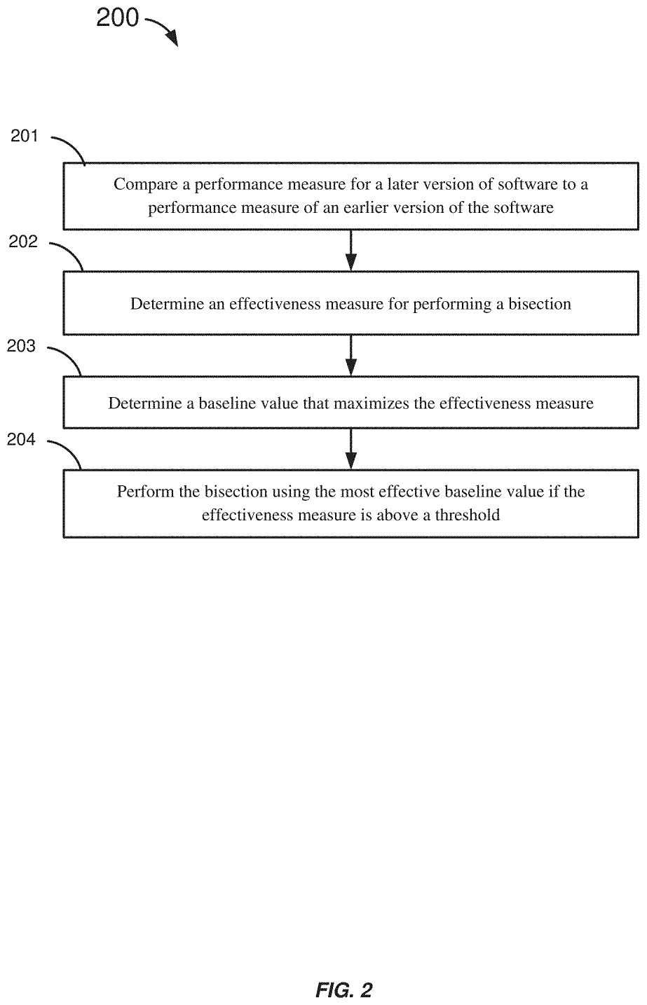

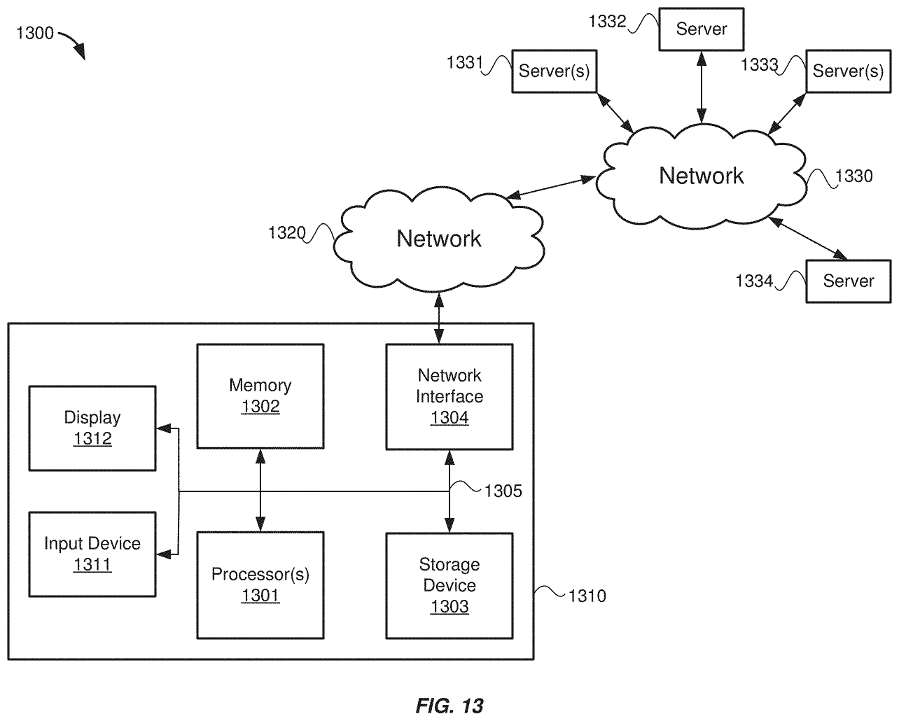

FIG. 2 shows a flowchart 200 of a method for determining a bisection effectiveness measure, according to an embodiment. The method may be performed by a computer system, such as the software test system 110 described above with respect to FIG. 1, or the computer system 1310 described below with respect to FIG. 13.

At 201, the method may compare a performance measure for a later version of software to a performance measure of an earlier version of the software, where a difference between the performance measure for the later version and the performance measure for the earlier version indicating a performance regression of the software. For instance, if lower performance measures indicate better performance, then if the performance measure for the later version is greater than some baseline value (which is greater than or equal to the performance measure of an earlier version of the software) that would indicate a performance regression of the software (e.g., the performance measure is higher and so the performance is worse). In some embodiments, the method may further measure performance of an operation of the software in a plurality of tests and determine the second performance measure by aggregating the performance of the operation in the plurality of tests. For example, if the performance regression is a slow-down of that operation, numerous tests may be conducted to measure the time it takes for that operation to complete. A certain number of tests may be conducted in order to achieve a certain level of statistical significance. The performance measure may be average time across the tests, for example. The performance values tested represent a distribution of the performance for that commit. If this distribution of tested performance values changes (e.g., for the worse), that may be referred to as a “shift” in the distribution herein.

At 202, the method may determine an effectiveness measure for performing a bisection based on a first probability that a shift in distribution of performance measures of a plurality of versions of the software (i.e., a “Commit”) occurs at a particular version of the software given that a bisection would identify that particular version of the software as having the performance regression. As further described below, this effective measure may be formulated as P(shift is at C| B( )=C), which may be reformulated according to Bayes' Law as:

P(shift is at C|B( )=C)=P(B( )=C|shift is at C)P(shift is at C)/P(B( )=C)

The effectiveness measure may be determined using this equation for a particular commit C and using a particular baseline value, as discussed below. An average effectiveness measure across all commits that may have potentially introduced the software regression may be determined by computing the effectiveness measure at each commit. The average effectiveness measure may indicate the accuracy or effectiveness of the bisection when using the particular baseline value.

In some embodiments, the method may determine a second probability that the bisection would identify the particular commit as having the performance regression given that the shift in distribution of performance measures of the plurality of versions of the software occurs at the particular version of the software, wherein the determination of the first probability is based on the second probability. This second probability may be formulated as: P(B( )=C|shift is at C).

In some embodiments, the method may determine a third probability that the shift in distribution of performance measures of the plurality of versions of the software occurs at the particular version of the software based on a number of the plurality of versions of the software, wherein the determination of the first probability is based on the third probability. This third probability may be formulated as: P(shift is at C).

In some embodiments, the method may determine a fourth probability that the bisection would identify the particular commit as having the performance regression, wherein the determination of the first probability is based on the fourth probability. This fourth probability may be formulated as: P(B( )=C).

At 203, the method may determine a baseline value that maximizes the effectiveness measure. In some embodiments, a set of baseline values includes values between the performance measure of the earlier version of the software and the performance measure for the later version of software. Using this set, a baseline value that maximizes the effectiveness measure from among the set may be determined by calculating a plurality of effectiveness measures over the set of baseline values.

In some embodiments, the determination of the baseline value that maximizes the effectiveness measure includes conducting a binary search on a set of possible baselines between the first performance measure and the second performance measure, values of possible baselines in the set of possible baselines determined based on an increment value from a value of the first performance measure or the second performance measure.

At 204, the method may perform the bisection using the most effective baseline value from among the set if the effectiveness measure is above a threshold. The threshold may be selected by a software developer based on their experience, for example. For example, a threshold of 50% may be used. That is, the bisection has a 50% probability of accurately identifying the commit that introduced the performance regression. Other probabilities may be used as thresholds.

This method for determining effectiveness measures and an effective baseline value for performing a bisect are further described below.

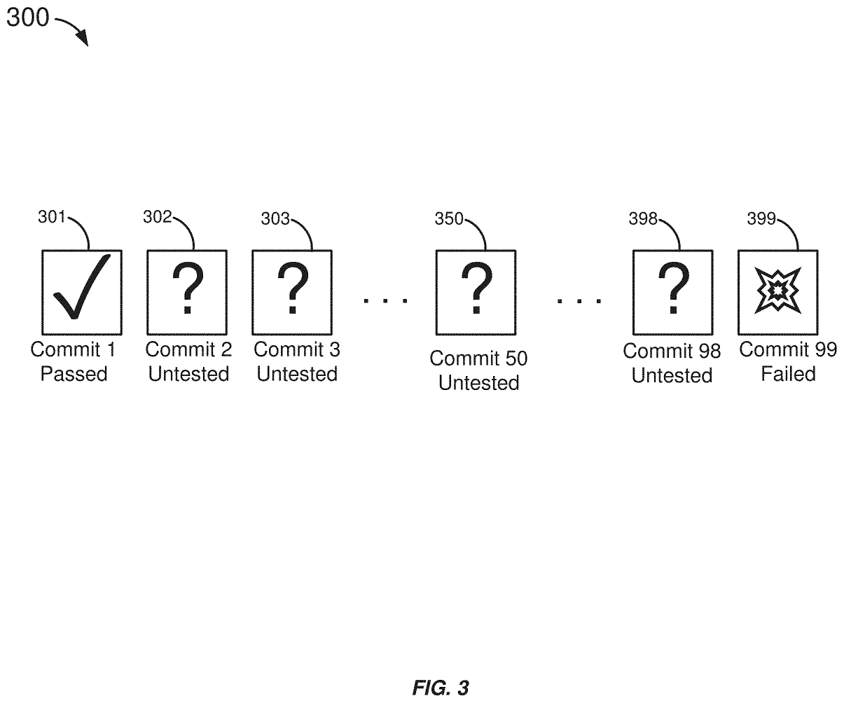

FIG. 3 shows a diagram 300 of a software performance regression localization problem, according to an embodiment. In this example, “commit 1” 301 was performance tested (e.g., by performance test software module 112) and passed (e.g., the performance was equal to or better than the baseline). The diagram 300 also shows “Commit 2” 302, “Commit 3” 303, with “Commit 4” to “Commit 49” left out and represented by ellipsis, “Commit 50” 350, “Commit 51” to “Commit 97” left out and represented by ellipsis, “Commit 98” 398, and “Commit 99” 399. In this example, a software developer may run daily regression tests on an application. On Day 1, the regression test runs on “Commit 1” 301, which is the then-latest commit, and reports that it passed (e.g., no failures). However, on Day 2, the regression test runs on “Commit 99” 399, which is the latest commit, and the test reports a failure. “Commit 2” 302 though “Commit 98” 398 are untested as of yet. Not every commit may be tested because performance testing may be time consuming and resource intensive.

The goal of the software developer may be to find the first commit to manifest the loss in performance (which may be referred to as a software “bug”). One technique to do this is to perform a bisection as described here. When performing a bisection, the middle commit is the first commit to test. In this case, “Commit 50” 350 is the middle commit between “Commit 1” 301 and “Commit 99” 399. The bisection is performed by testing each middle commit and then searching recursively either on the left side or the right side of the list of commits, depending on the test results. If “Commit 50” 350 (the middle commit) passes, then the performance regression may have been introduced in a later commit and so the bisection next tests the middle commit of the commits to the right (the later commits). If “Commit 50” 350 fails, then the performance regression may have been introduced in an earlier commit and so the bisection next tests the middle commit of the commits to the left (the earlier commits). As such, a bisection searches in a binary search fashion. The search space is reduced each time that the performance is tested, and the search space selected to be searched next is selected based on a comparison of the measured performance with the baseline performance value. This process may proceed recursively until there are only two commits remaining, at which point the second of these two commits is output as the bug-introducing commit.

The metric used to determine whether to continue the search on the left side of the array of commits or the right side of the array of commits is called the bisection metric. In the case of functional regressions, the metric used is “correctness” (i.e., does the test output the correct value or not, based on the specifications?). On the other hand, for performance regressions, the metric used is numerical, and the decision to either take the left side or the right side of the array is based on a comparison with a baseline value. Referring back to FIG. 1, the bisection software module 113 may perform the bisection process described herein.

Performance regressions may be difficult to localize using traditional debugging techniques, as many of these techniques are intrusive with respect to performance; for instance, setting breakpoints may change the underlying response time of an application. In contrast, bisection is minimally intrusive, as it simply runs performance regression tests without any external interference (e.g., from the developer). In addition, as with functional regressions, performance regression bisection only cares about the final result of the regression test, which allows the developer to abstract out the details of why the performance regressed, and defer answering that question until the bisection provides an output; thus, the human effort required is reduced from a search-and-validation problem to simply a validation problem, which itself is simplified by a post-facto analysis of the code changes in the commit output by the bisection. Further, bisection is simple and intuitive when applied to performance bugs, with bisection paths taken based on a simple comparison with a baseline value; this simplicity is particularly important when validating the output of the bisection. Lastly, performance regression tests—especially end-to-end tests—often take a long time to execute since many samples of a performance metric need to be collected in order to generate a statistically significant result. As a result, performance regression tests often cannot be run on a per-commit basis, which means a search needs to be conducted across multiple commits when localizing a performance regression; bisection provides an efficient (e.g., O(log n)) way to conduct this search. Referring back to FIG. 1, such performance tests may be performed by the performance test software module 112.

While advantageous, bisection may introduce challenges when applied to performance regressions. Unlike functional regressions, the bisection metric (e.g., baseline performance value) used to determine the bisection path is a numerical value with (often high) variance. Therefore, the choice of a bisection metric is much more crucial for performance regressions, both in terms of its stability and the baseline value used. As a corollary to the high variance, while monotonicity of the bisection metric is not guaranteed even for functional regressions, the bisection metric for performance regressions is almost guaranteed to not be monotonic, which once again makes the choice of the baseline value crucial. Finally, as discussed further below, the amount of time it takes to run a performance regression bisection can be very high. Hence, it would be advantageous to know if running a bisection is worth the time and resource investment, and if so, what parameters are needed to minimize the chances of a failed bisection. These challenges in accuracy and time cost point to the need for a better understanding of the effectiveness of bisection on performance regressions.

### Definitions

The present disclosure describes techniques to identify and analyze the main properties that contribute to the effectiveness of a bisection. These properties are referred to as the contributing properties. This technique may help developers easily assess whether bisection is a suitable technique to use for specific performance regression localization problems. Making this assessment is important as performance regression tests, especially end-to-end regression tests, can take a long time to run. This means the bisection itself takes a long time to execute, as it may have to run several of these tests. Thus, running a failed bisection can be very costly in time and computing resources. In one study, for example, single iteration end-to-end tests may run between 30-160 seconds without test parallelization, and 15-71 seconds with test parallelization. Since performance regression tests require multiple iterations in order to establish statistically significant values to compare against the baseline, these numbers may be even higher. For example, with 50 iterations, the tests may take 25-133 minutes without test parallelization, and 12.5-59 minutes with test parallelization. While the values above are representative of typical performance numbers that developers may normally see in practice, the numbers themselves do not represent a strict range of values and in other situations the time to run tests may be different. Also, these values also do not account for the amount of time it takes to deploy or install a particular version of an application. Deploying or installing may take several minutes for large applications and this may need to be done multiple times for multiple versions of the application throughout the bisection. In this case, given a particular performance regression to localize, having a deeper understanding of the effectiveness of bisection and its contributing parameters may allow the software developer to know whether bisection is an appropriate solution in the first place, and if so, what bisection metric and baseline to use that may maximize the effectiveness.

As further described below, a metric that measures the effectiveness of a bisection when applied to a performance regression may be derived. This is referred to as the “effectiveness measure” here. Some intuitions that lead to an informal definition of effectiveness are first presented. Thereafter, the concepts of performance regression and bisection, which also lead to a formal definition for effectiveness that is in line with the intuition are presented. After which an algorithm to compute this effectiveness measure using Bayesian analysis is described.

Two intuitions for formulating effectiveness are presented. The first intuition is that a particular bisection being “effective” means that the bisection has resulted in the correct bug-introducing commit being identified. This follows directly from the goal of performance regression localization, which is precisely to find this bug-introducing commit. Based on this intuition alone, the “effectiveness” of a bisection may be defined as the probability that the bisection outputs the correct commit. There is also a need to define what it means for the bisection to provide the correct commit.

The second intuition is that when localizing performance regressions, the bisection metric for each commit, which is a numerical metric as discussed above, may follow a specific distribution given repeated measurements of that same metric, with some aggregate value of interest that describes this distribution, the median for example. The bisection technique may assume that everything before the bug-introducing commit (introducing the performance regression) has roughly the same median M or smaller, and everything from the bug-introducing commit onwards may have a median greater than M. Given that this property required by bisection holds, the goal of bisection would then be to find the first commit where the distribution changes. In particular, from one with a median of M or smaller, to one with a median greater than M.

Therefore, taking the above two intuitions together, a definition for effectiveness follows: the probability that the bisection outputs the first commit (in the array of commits) where the distribution shifts. The definition can be rewritten more concretely in terms of a conditional probability: the probability that the first commit (in the array of commits) where the distribution shifts is Commit C, given that bisection output C. This informal definition forms the basis for our more formal definition presented below.

Before defining the effectiveness measure itself, definitions of a performance regression, a halving function, a bisection, and a bug-introducing commit are provided.

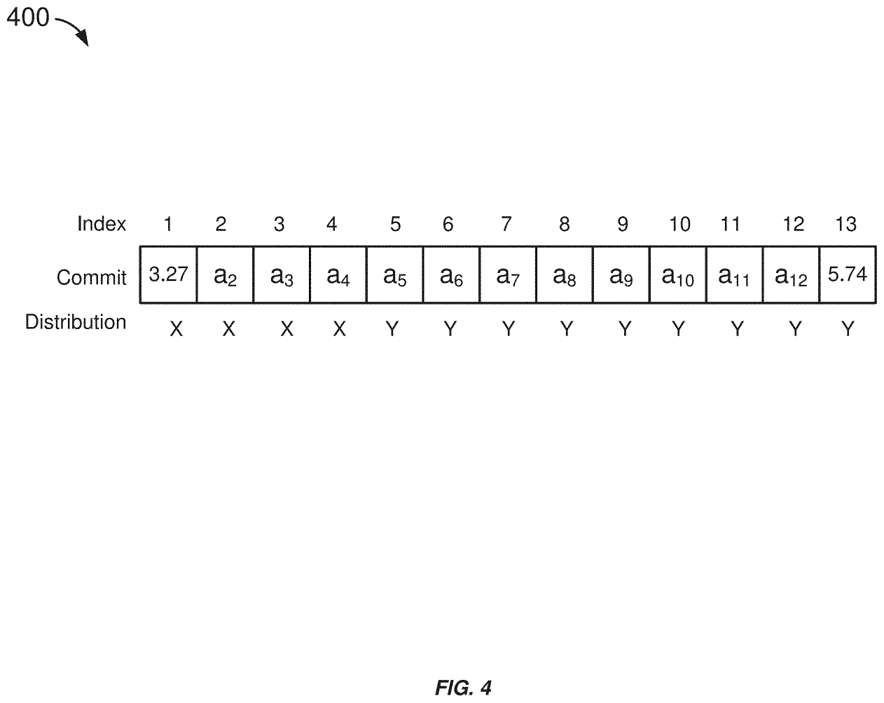

FIG. 4 shows a diagram 400 of a performance regression, according to an embodiment. In diagram 400, the performance regression is represented by a 13-tuple, according to an embodiment. The diagram 400 shows thirteen commits (e.g., different versions of software committed to a repository) indexed from 1 to 13, a performance measure for the commit (e.g., 3.27 for commit 1, a2 for commit 2, a3 for commit 3, and so on up to 5.74 for commit 13). The diagram 400 also shows the distribution of the performance measure. The performance measure being an aggregation (e.g., mean, median, etc.) of values corresponding to a plurality of performance tests. The “distribution” being the distribution of values recorded for the plurality of tests on that commit. As shown in the diagram 400, the distributions have been abstracted such that the commits indexed from 1-4 have a distribution of X and commits indexed from 5-13 have a distribution of Y. In this example, performance having a distribution of Y indicates a performance regression (e.g., comparatively poor performance) compared to the distribution X. In this example, the distribution is said to “shift” at index 5, which is the first commit to have the new distribution Y.

This way to represent a performance regression is used to define the performance regression as further described below. Consider an n-tuple indexed from p to q, with the first element equal to s ∈ [symbol] , the last element equal to t ∈ [symbol] , and the remaining elements equal to real numbers of unknown value. For simplicity, we denote such n-tuples as [symbol] (s, t, p, q), where q−p+1=n≥2, and for each element aᵢ at index i in the tuple:

$${a}_{i} = \{ \begin{matrix}s & i = p \\ {w}_{i} & p < i < q , s . t . {w}_{i} ∈ \\ t & i = q\end{matrix}$$

From the above, a performance regression is defined as follows:

A performance regression is an n-tuple [symbol] (s, t, p, q) such that t>s and q−p+1=n≥2. Each element of a performance regression may also be referred to as a commit herein.

By making this definition, a performance regression is modeled as a tuple (i.e., array), which is the level of abstraction that may be used by bisection. In particular, the n-tuple represents the array of commits (e.g., the array representing the actual different versions of software committed to the repository), where the first element (indexed at p) has value s for some performance metric of interest, and the last element (indexed at q) has value t>s for the same metric.

Referring back to FIG. 4, the diagram 400 shows an example of a performance regression with 13 commits, where the first commit at index 1 has value 3.27 and the last commit at index 13 has value 5.74 (which is greater than the value of the first commit). This performance regression can model a scenario where, for instance, opening a particular feature in an application previously had a median response time of 3.27 seconds, but now has a median response time of 5.74 seconds, twelve commits later. As discussed above, it would be advantageous for a software developer to quickly identify the commit that introduced this regression, using as fewer computing resources, such that the bug can be discovered and corrected, thereby removing or reducing the performance regression.

Before we define a bisection, the following definitions are presented first to simplify the notation. [symbol] is defined as the set of all performance regressions and 1-tuples:

[symbol]

={ [symbol] (s,t,p,q)|t>s,q>p}∪{[r]r∈ [symbol] }

The halving function is a function h: [symbol] → [symbol] such that, for all x∈ [symbol] where x is either a 1-tuple or a performance regression [symbol] (s,t,p, q):

$$h ( x ) = \{ \begin{matrix}( s , {a}_{⌊ \frac{p + q}{2} ⌋} , p , ⌊ \frac{p + q}{2} ⌋ ) & {a}_{⌊ \frac{p + q}{2} ⌋} > s and q - p > 1 \\ ( s , t , ⌊ \frac{p + q}{2} ⌋ , q ) & {a}_{⌊ \frac{p + q}{2} ⌋} \leq s and q - p > 1 \\ [ t ] & q - p = 1 \\ x & x is a 1 - tuple\end{matrix}$$

$$where {a}_{⌊ \frac{p + q}{2} ⌋} is the value of the element in the tuple ( s , t , p , q ) at index ⌊ \frac{p + q}{2} ⌋ .$$

The halving function may represent one iteration of a bisection. In particular, if the middle element a└(p+q)/2┘ has a value greater than the baseline s, the left half of the array remains; if, on the other hand, the middle element has a value less than or equal to the baseline, the right half of the array remains. Going back to FIG. 4, the middle commit of this specific performance regression is at index 7, where the value is a₇. In addition, the baseline value is 3.27. Thus, if a₇>3.27, the halving function outputs the left half of the array. That is, the subtuple from index 1 to index 7. Otherwise, if a₇≤3.27, the halving function outputs the right half of the array. That is, the subtuple from index 7 to index 13, with the value at Commit 7 replaced by the baseline 3.27; the purpose of replacing the value at Commit 7 when taking the right half is to ensure that we are always comparing against the same baseline, which in turn ensures consistency in the comparisons. In practical terms, the value of a₇ represents the value of the bisection metric that results from running a performance test on Commit 7.

From the above, bisection is defined as follows:

A bisection is a function B: [symbol] → [symbol] such that for all x∈ [symbol] where x is either a 1-tuple or a performance regression [symbol] (s, t, p, q):

$$B ( x ) ≡ \{ \begin{matrix}B ( h ( x ) ) & q - p > 1 \\ q & q - p = 1 \\ i & x is a 1 - tuple indexed at i\end{matrix}$$

That is, a bisection is a repeated application of the halving function on a performance regression x. This process continues recursively until the input to the bisection is either a 2-tuple (in which case it outputs the index of the second element) or a 1-tuple indexed at i (in which case it outputs i).

Based on the intuitions presented above, the distribution (of a given bisection metric) may be modeled for each commit in the performance regression. One of the underlying properties that may be required by a bisection when applied to a performance regression is that all commits prior to the bug-introducing commit follow roughly the same distribution with median M, for example, and all commits from the bug-introducing commit onwards also follow another distribution with median greater than M. Based on this intuition, given a performance regression [symbol] T(s, t, p, q), we may model the distribution of the commits from index p to index r−1 with the same continuous random variable X, and we may model the distribution of the commits from index r to index q with the same continuous random variable Y, where r is the index of the bug-introducing commit. The variables X and Y corresponding to the commit index is shown in FIG. 3. Furthermore, one goal of bisection is to find the bug-introducing commit. Its location is initially unknown. We may formally define the bug-introducing commit as a random variable, as follows:

Accordingly, a definition of the bug-introducing commit is now provided. Given a performance regression x= [symbol] (s, t, p, q), define the bug-introducing commit Dₓ of x as a discrete random variable whose value represents the index of the first element in x where the distribution shifts from X to Y. That is, the index of the first element in x that has distribution Y. This means that Dₓ has {p+1, . . . q−1, q} as its sample space, as the first element of the performance regression (indexed at p) is assumed to follow distribution X.

Referring back to FIG. 4, in this example, the distribution from index 1 to index 4 is X, and the distribution shifts to Y at index 5. Thus, if we represent this performance regression with the variable x, then by the definition of the bug-introducing commit provided above, Dₓ=5 in this example. To reiterate, the bug-introducing commit is unknown initially, so Dₓ=5 is simply one of several (e.g., twelve in the example of FIG. 3) possible values for the random variable Dₓ.

Based on the above definitions, effectiveness is defined as follows:

Given a performance regression x= [symbol] (s, t, p, q), the effectiveness measure (effectiveness) ϵ_{x,c} of x with respect to a bisection output c is defined as:

ϵ_{x,c}≡P(Dₓ=c|B(x)=c)

As stated above, the effectiveness measure corresponds to the probability that the bug-introducing commit in the performance regression occurs at index c, given that bisection itself output index c. Note that this effectiveness measure is applicable only to a very specific output c of the bisection. Further below is defined an aggregated measure that is averaged over all possible outputs of the bisection, which is useful as it allows us to measure the effectiveness of a particular bisection independent of the bisection output. The above definition for effectiveness is used as the starting point of the derivation.

Derivation of the Effectiveness Measure

The effectiveness measure is formally defined above. Next, an algorithm to compute the effectiveness measure may be defined. As a preliminary observation, note that the effectiveness measure can be rewritten using Bayes' theorem as in Equation 1:

$${ϵ}_{x , c} = \frac{P ( B ( x ) = c \vert {D}_{x} = c ) P ( {D}_{x} = c}{P ( B ( x ) = c )} \qquad ( 1 )$$

This rewritten form provides a framework for the derivation as it suffices to compute the following individual probabilities, which are taken from the right-most side of the above identity.

$$\{ \begin{matrix}P ( B ( x ) = c \vert {D}_{x} = c ) & Likelihood ( λ ) \\ P ( {D}_{x} = c ) & Shift Probability ( σ ) \\ P ( B ( x ) = c ) & Output Probability ( ω )\end{matrix}$$

The likelihood λ can be computed as λ=P(B(x)=c|Dₓ=c) for a given performance regression x= [symbol] (s, t, p, q). Before proceeding with the derivation, the following definition helps simplify the notation.

Consider a performance regression x= [symbol] (s, t, p, q). Define Zᵢ^{Dx=c} as the distribution at commit i of x, given that Dₓ=c (i.e., given that the distribution shifts from X to Y at commit c, as per the definition of the bug-introducing commit), where p≤i≤q. That is:

$${Z}_{i}^{{D}_{x} = c} ≡ \{ \begin{matrix}X & p \leq i < c \\ Y & c \leq i \leq p\end{matrix}$$

From the example in FIG. 3, suppose that Dx=5 (as shown in FIG. 3). By the definition above, this means that Z₁^{Dx=5}, Z₂^{Dx=5}, Z₃^{Dx=5}, and Z₄^{Dx=5} all follow the distribution X, and that Z₅^{Dx=5} through Z₁₃^{Dx=5} all follow the distribution Y. Now the likelihood can be derived. First, from elementary probability, we can rewrite λ, noting that

$${Z}_{⌊ \frac{p + q}{2} ⌋}^{{D}_{x} = c} > s and {Z}_{⌊ \frac{p + q}{2} ⌋}^{{D}_{x} = c} \leq s$$

are mutually exclusive events. The likelihood λ is rewritten as follows:

$$\begin{matrix}λ = P ( B ( x ) = c \vert {D}_{x} = c ) \\ = P ( {Z}_{⌊ \frac{p + q}{2} ⌋}^{{D}_{x} = c} > s \vert {D}_{x} = c ) P ( B ( x ) = c \vert {D}_{x} = c , {Z}_{⌊ \frac{p + q}{2} ⌋}^{{D}_{x} = c} > s ) + \\ P ( {Z}_{⌊ \frac{p + q}{2} ⌋}^{{D}_{x} = c} \leq s \vert {D}_{x} = c ) P ( B ( x ) = c \vert {D}_{x} = c , {Z}_{⌊ \frac{p + q}{2} ⌋}^{{D}_{x} = c} \leq s )\end{matrix}$$

For simplicity, define

$$m = ⌊ \frac{p + q}{2} ⌋$$

to rewrite the above expression as follows:

λ=P(Zₘ^{D}^{ₓ}^{=c}>s|Dₓ=c)P(B(x)=c|Dₓ=c,Zₘ^{D}^{ₓ}^{=c}>s)+P(Zₘ^{D}^{ₓ}^{=c}≤s|Dₓ=c)P(B(x)=c|Dₓ=c,Zₘ^{D}^{ₓ}^{=c}≤s)

The above expression splits the probability into two mutually exclusive cases: one in which the result of the middle commit is greater than the baseline s, and another in which the result of the middle commit is less than or equal to s. Note, however, that both Zₘ^{D}^{ₓ}^{=c}>s and Zₘ^{D}^{ₓ}^{=c}≤s are independent from Dₓ=c, because based on the definition of the distribution at commit i of x, Zₘ^{D}^{ₓ}^{=c} implicitly supposes a particular value for Dₓ (which effectively supersedes whatever condition on the value of Dₓ is provided in the probability expression). We can therefore simplify λ as follows:

λ=P(Zₘ^{D}^{ₓ}^{=c}>s)P(B(x)=c|Dₓ=c,Zₘ^{D}^{ₓ}^{=c}>s)+P(Zₘ^{D}^{ₓ}^{=c}≤s)P(B(x)=c|Dₓ=c,Zₘ^{D}^{ₓ}^{=c}≤s)

Furthermore, given that the value of the middle commit exceeds the baseline (i.e., Zₘ^{D}^{ₓ}^{=c}>s), the following holds from the definitions of bisection and halving function, where aₘ is the value at the middle commit:

B(x)=B( [symbol] (s,t,p,q))=B(h( [symbol] (s,t,p,q)))=B( [symbol] (s,aₘ,p,m))

Similarly, given that the value of the middle commit is less than or equal to the baseline (i.e., Zₘ^{D}^{ₓ}^{=c}≤s), then we have the following case by the definitions of bisection and halving function:

B(x)=B( [symbol] (s,t,p,q))=B(h( [symbol] (s,t,p,q)))=B( [symbol] (s,t,m,q))

Thus, in the expression for λ, we can expand B(x)=c according to the relevant case:

λ=P(Zₘ^{D}^{ₓ}^{=c}>s)P(B( [symbol] (s,aₘ,p,m))=c|Dₓ=c,Zₘ^{D}^{ₓ}^{=c}>s)+P(Zₘ^{D}^{ₓ}^{=c}≤s)P(B( [symbol] (s,t,m,q))=c|Dₓ=c,Zₘ^{D}^{ₓ}^{=c}≤s)

The values of B( [symbol] (s, aₘ, p, m)) and B( [symbol] (s, t, m, q)) no longer depend on the value of the commit at index m. This is evident from the definitions of bisection and halving function. These expressions represent the next recursive iteration of the bisection when the result at index m is already known. Therefore, we can remove the conditions Zₘ^{D}^{ₓ}^{=c} as follows:

λ=P(Zₘ^{D}^{ₓ}^{=c}>s)P(B( [symbol] (s,aₘ,p,m))=c|Dₓ=c)+P(Zₘ^{D}^{ₓ}^{=c}≤s)P(B( [symbol] (s,t,m,q))=c|Dₓ=c)

From the definition of bisection, the bisection function outputs a value between the two endpoints of the performance regression tuple, not including the left endpoint. This means that if c≤m, then the index c would lie outside the possible values of B( [symbol] (s, t, m, q)). Hence, in this scenario, P(B( [symbol] (s, t, m, q)))=c|Dₓ=c)=0. Similarly, if c>m, then c would lie outside the possible values of B( [symbol] (s, aₘ, p, m)) and thus, in this scenario, P(B( [symbol] (s, aₘ, p, m))=c|Dₓ=c)=0. Given these observations, λ can be written piecewise:

$$λ = \{ \begin{matrix}P ( {Z}_{m}^{{D}_{x} = c} > s ) P ( B ( 𝒯 ( s , {a}_{m} , p , m ) ) = c \vert {D}_{x} = c ) & c \leq m \\ P ( {Z}_{m}^{{D}_{x} = c} \leq s ) P ( B ( 𝒯 ( s , t , m , q ) ) = c \vert {D}_{x} = c ) & c > m\end{matrix}$$

As a final step, P(Zₘ^{D}^{ₓ}^{=c}>s) and P(Zₘ^{D}^{ₓ}^{=c}≤s) can be rewritten in terms of the cumulative distribution function F_{Z}_{ₘ}_{^{Dx=c}}(s), which gives us Equation 2:

$$λ = P ( B ( 𝒯 ( s , t , p , q ) ) = c \vert {D}_{x} = c ) = \{ \begin{matrix}( 1 - {F}_{{Z}_{m}^{{D}_{x} = c ( s ) )}} P ( B ( 𝒯 ( s , {a}_{m} , p , m ) ) = c \vert {D}_{x} = c ) & c \leq m \\ ( {F}_{{Z}_{m}^{{D}_{x} = c ( s ) )}} P ( B ( 𝒯 ( s , t , m , q ) ) = c \vert {D}_{x} = c ) & c > m\end{matrix} \qquad ( 2 )$$

Programmatically, Equation 2 can be used to compute λ recursively, taking either the first case or the second case depending on the value of the midpoint

$$\breve{m = ⌊ \frac{p + q}{2} ⌋ .}$$

Next, the shift probability is denoted by σ=P(Dₓ=c). In this case, given no additional information, Dₓ can be modeled as a uniformly distributed random variable, with each of its possible values having equal probability. As mentioned in the definition of the bug-introducing commit, the sample space of Dₓ is {p+1, . . . , q−1, q} for a given performance regression [symbol] (s, t, p, q). Thus, we can compute σ as Equation 3:

$$σ = P ( {D}_{x} = c ) = \{ \begin{matrix}\frac{1}{q - p} & p < c \leq q \\ 0 & otherwise\end{matrix} \qquad ( 3 )$$

Next, the output probability is denoted by ω=P(B(x)=c). Given x= [symbol] (s, t, p, q))), the events Dₓ=p+1, Dₓ=p+2, . . . Dₓ=q−1, Dₓ=q are all mutually exclusive and encompass the entirety of the sample space for Dₓ (by the definition of the bug-introducing commit). Thus, ω can be written as Equation 4:

$$ω = P ( B ( x ) = c ) = {\sum }_{i = p + 1}^{q} P ( {D}_{x} = i ) P ( B ( x ) = c \vert {D}_{x} = i ) \qquad ( 4 )$$

In Equation 4 above, the value of P(Dₓ=i) for each i can be computed using Equation 3. The value of P(B(x)=c|Dₓ=i) can be computed using the following equation, whose derivation is omitted here as it is very similar to the derivation for the likelihood (i.e., Equation 2).

$$P ( B ( 𝒯 ( s , t , p , q ) ) = c \vert {D}_{x} = i ) = \{ \begin{matrix}( 1 - {F}_{{Z}_{m}^{{D}_{x} = i}} ( s ) ) P ( B ( ( s , {a}_{m} , p , m ) ) = c \vert {D}_{x} = i ) & c \leq m \\ ( {F}_{{Z}_{m}^{{D}_{x} = i}} ( s ) ) P ( B ( ( s , t , m , q ) ) = c \vert {D}_{x} = i ) & c > m\end{matrix}$$

If Dₓ is modeled to be uniform, as in Equation 3, then P(Dₓ=i) stays constant for all p<i≤q. Therefore, combining Equations 1 and 4, the effectiveness measure calculation can be simplified as follows:

$${ϵ}_{x , c} = \frac{P ( B ( x ) = c \vert {D}_{x} = c )}{{\sum }_{i = p + 1}^{q} P ( B ( x ) = c \vert {D}_{x} = i )}$$

Given Equations 2, 3, and 4, the effectiveness ϵ_{x,c} for a given output index c can be computed. However, since the output of the bisection is unknown prior to running it, it would be desirable to measure the overall effectiveness of bisection on a given performance regression x regardless of the output. The average effectiveness may be used as an aggregate measure.

Average effectiveness is defined as follows. Given a performance regression x= [symbol] (s, t, p, q), denote the average effectiveness of bisection B(x) by ϵ_{x,avg}, and define it as follows:

$${ϵ}_{x} , avg ≡ {\sum }_{i = p + 1}^{q} {ϵ}_{x , i} P ( B ( x ) = i )$$

The above definition is based on the expected value of the effectiveness, given the probability of each possible output of B(x). Note, P(B(x)=i) can be computed for each i using the equation for the output probability (Equation 4). The following simplification, based on Equation 1, can help speed up the computation of ϵ_{x,avg}:

$$\vert {ϵ}_{x} , avg = {\sum }_{i = p + 1}^{q} P ( B ( x ) = i \vert {D}_{x} = i ) P ( {D}_{x} = i )$$

With uniform Dₓ, this equation can be further simplified to the following.

$${ϵ}_{x} , avg = \frac{1}{q - p} {\sum }_{i = p + 1}^{q} P ( B ( x ) = i \vert {D}_{x} = i )$$

The effectiveness of a particular bisection may be computed based on the average effectiveness. In the description below, the terms “effectiveness” and “average effectiveness” may be used interchangeably whenever the context is clear.

Contributing Properties

With a formal definition of effectiveness above, the contributing properties, which are the properties of a performance regression that can potentially impact the effectiveness of a bisection, can be determined.

A first contributing property is the Baseline. From Equations 2 and 4 above, the values of the likelihood and the output probability depend on the cumulative distribution function (CDF) of the distribution at each commit (e.g., Equation 2 depends on

$${{F}_{{Z}_{m}^{{D}_{x} = c}} ( s )}_{)} .$$

The CDF calculations have, as their input, the value of the baseline s. This dependency indicates that the baseline value is a contributing property.

A second contributing property are the Distributions. Since the likelihood and output probability both depend on the CDFs as just mentioned, then the value of effectiveness is also potentially impacted by the characteristics of the distribution before the regression (i.e., X) and the distribution after the regression (i.e., Y). In turn, this observation implies that the distributions X and Y are contributing properties.

A third contributing property is the Commit Range Length. The length of the commit range is also a contributing property as it affects the value of the likelihood and the output probability. In particular because Equation 2 is computed recursively and the number of recursive iterations depends on the commit range length. The commit range length also affects the value of the shift probability, as is evident in Equation 3. However, as discussed above, the shift probability gets cancelled out from the effectiveness measure computation when Dₓ is uniform.

A fourth contributing property is the Transition Index. From Equations 2 and 4, the value of the bisection output c also has an impact when computing the likelihood and the output probability. This value is called the transition index. Note that this value may not affect the average effectiveness, as the bisection output is abstracted out from the average effectiveness calculation as per the definition of average effectiveness. However, it may still be advantageous to study the effect that this value has on the “per bisection output” effectiveness ϵ_{x,c}, as ϵ_{x,c} can still be used for postfacto analysis. In particular, while ϵ_{x,avg} can help developers answer questions such as, “How effective will this bisection be?” prior to running the bisection, and ϵ_{x,c} can help developers answer, “How effective was the bisection that just ran?”

Exemplary Bisection

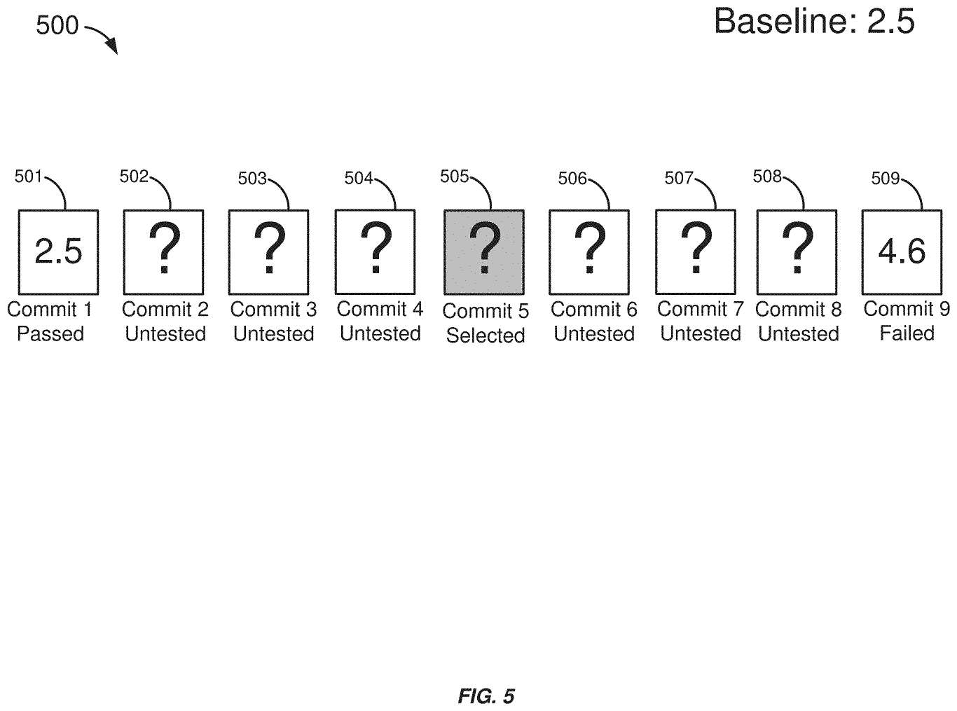

As discussed above, a bisection may be used to localize a performance regression from among a plurality of different versions of the software (e.g., a plurality of commits). An effectiveness measure may be calculated and used to determine whether performing the bisection would be effective or not. In addition, the baseline value to use in conducting the bisection may be determined. An exemplary bisection is described below with respect to FIGS. 5-8.

FIG. 5 shows a diagram 500 of an exemplary bisection, according to an embodiment. As shown in diagram 500, this example involves nine different versions of software committed to a repository labeled as “Commit 1-9” 501-509. In this example, the baseline performance value is 2.5. “Commit 1” 501 has been performance tested and has a performance measure of 2.5 which is equal to the baseline. In this case, lower performance measures indicate better performance. Here, “Commit 1” 501 has a performance measure of 2.5 which is equal to or better than the baseline value of 2.5 and so it has passed its performance test. After Commit 1, “Commit 2-9” 502-509 were committed to the repository. In this example, “Commit 9” 509 has been performance tested and has a performance measure of 4.6, which is higher (e.g., worse) than the baseline value of 2.5. As such, “Commit 9” 509 has failed the performance test. Therefore, one of “Commits 2-9” 502-509 may have introduced a performance regression into the software. As discussed above, a bisection can be used to perform a binary search on the array of commits 1-9 to identify a commit that likely introduced the software regression. However, because performance tests may vary due to other considerations (e.g., network or processing resource availability), the bisection may not always be accurate.

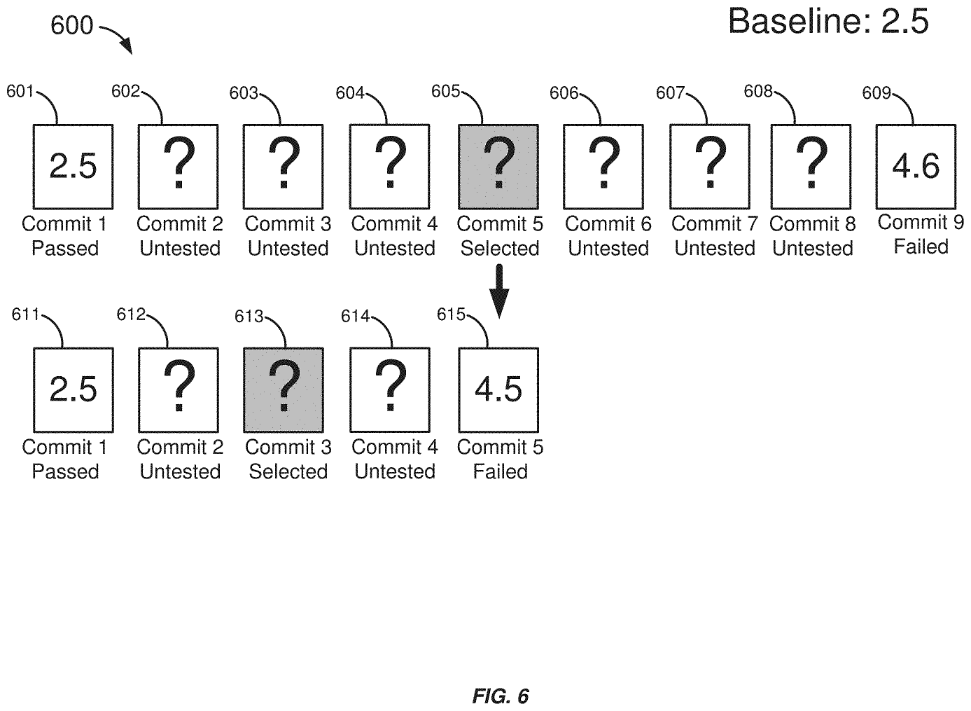

As discussed above, the bisection technique selects the commit in the middle to be tested and then proceeds to consider either the commits on the left-side or the right-side based on whether the middle commit failed or passed, respectively. In this example, “Commit 5” 505 is the middle commit and is selected for performance testing. Description of this exemplary bisection continues below with respect to FIG. 6.

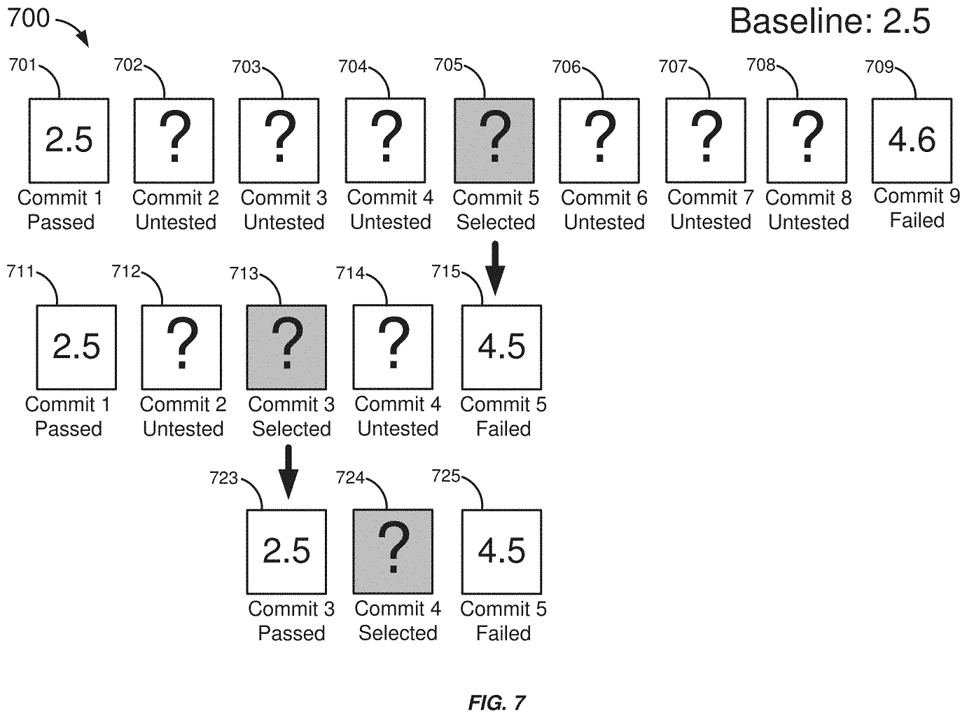

FIG. 6 shows a diagram 600 continuing the exemplary bisection from FIG. 5, according to an embodiment. In diagram 600, commits 601-609 correspond to commits 501-509 of FIG. 5. Diagram 600 shows that “Commit 5” 615, corresponding to commit 605, has been performance tested to have a performance measure of 4.5, which is higher (e.g., worse) than the baseline value of 2.5. Accordingly, Commit 5 has failed. Since Commit 5 has failed, it is possible that one of Commits 2-4 is the commit that introduced the performance regression. Accordingly, the bisection continues the binary search by selecting the middle commit of Commits 1-5 611-615 for performance testing, which is Commit 3 613. Description of this exemplary bisection continues below with respect to FIG. 7.

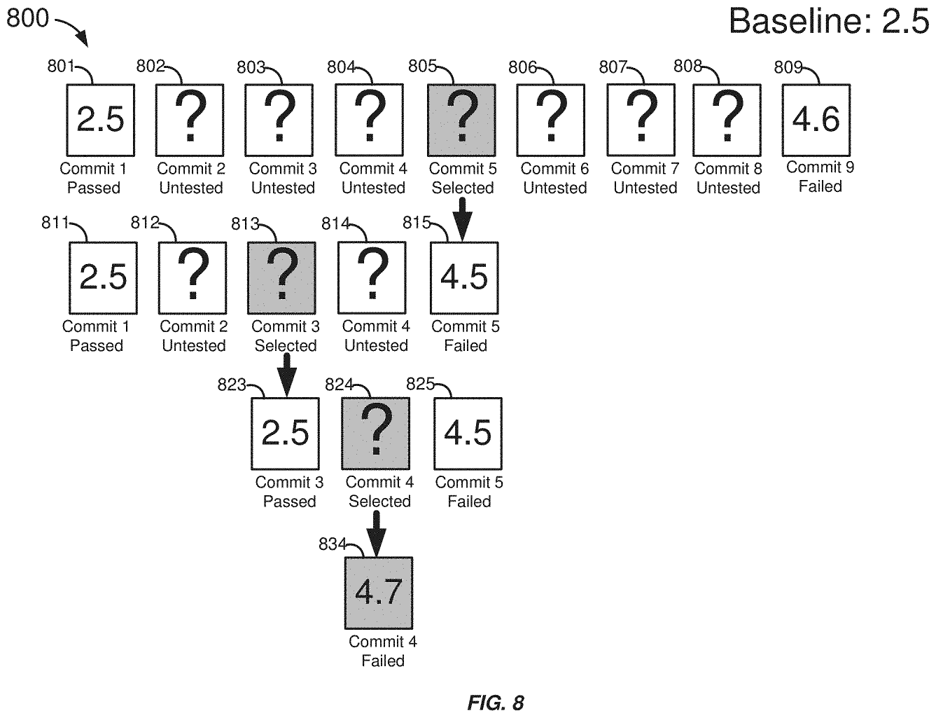

FIG. 7 shows a diagram 700 continuing the exemplary bisection from FIG. 6, according to an embodiment. In this diagram 700, Commits 701-709 correspond to commits 601-609 of FIG. 6 and commits 711-715 correspond to commits 611-615 of FIG. 6. Diagram 600 shows that commit 3 723, corresponding to Commit 713, has been performance tested and has a performance measure of 2.5, which is equal the to baseline value of 2.5. Accordingly, commit 3 723 has passed the performance test. Therefore, the bisection continues with selecting the middle commit of commits 3-5 723-725 for testing, which is commit 4 724. Description of this exemplary bisection continues below with respect to FIG. 8.

FIG. 8 shows a diagram 800 of the result of the exemplary bisection, according to an embodiment. In this diagram 800, commits 801-809, 811-815, and 823-825 correspond to commits 701-709, 711-715, and 723-725 of FIG. 7, respectively. Here, diagram 800 shows that Commit 4 834, corresponding to commit 824, was performance tested and has a performance measure of 4.7, which is higher (e.g., worse) than the baseline of 2.5. Accordingly, the result of the bisection is that Commit 4 824 introduced the performance regression.

Example of Determining Effectiveness Measure and Baseline

As mentioned herein, there may be a variance in tested performance values. So while bisection is applicable to performance regressions and can be useful, it may not have correctness guarantees. Furthermore, bisection takes a long time to run especially on performance regressions. In addition, validating false positives is wasted effort. Accordingly, there is a need to assess how effective a bisection will be. This need is met using the effectiveness measure described above. The effectiveness measure is advantageous because it may help software developers decide whether running bisection makes sense given the time and computing resources used, and it may help developers choose inputs (e.g., baseline, the bisection metric, etc.) that maximize the chances of an effective bisection compared to a set of possible inputs (e.g., a set of inputs based on an interval ranging from a performance measure for a working commit and the performance measure for a buggy commit). As discussed above, the effectiveness measure is formulated as the probability that the distribution shifted at commit C given that the bisection outputs C: P (shift is at C|B( )=C).

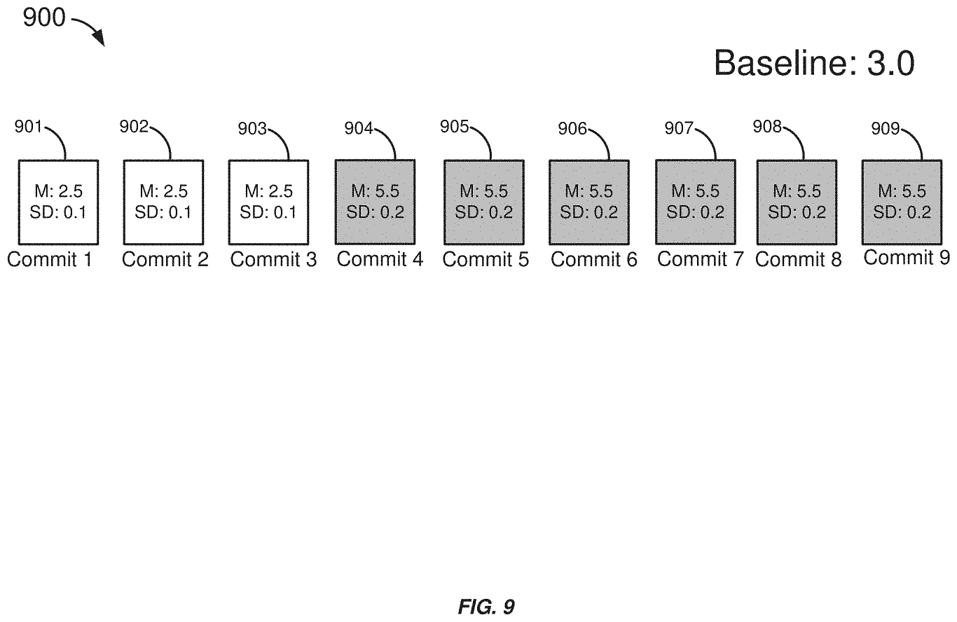

The formulation of the effectiveness measure is described above using the definitions and equations. This formulation of the effectiveness measure is further described below with respect to FIG. 9-12.

FIG. 9 shows a diagram 900 modeling software commits for determination of an effectiveness measure, according to an embodiment. This example includes nine commits 901-909 represented as an array of distributions. This array is labeled “Commit 1” 901 though “Commit 9” 909. In this model, the performance measure (e.g., mean or median) of the last commit (“Commit 9” 909) is greater than the performance measure (e.g., mean or median) of the first commit (“Commit 1” 901), when lower performance values indicate better performance. In this model, the distribution shifts as some (initially unknown) commit C, where C can be any commit except the first one (which has passed the performance test). Each commit has an associated performance measure “M” (e.g., aggregated measure such as mean or median) and a standard deviation “SD” corresponding to the aggregated measure (e.g., based on the distribution of the underlying performance values from a plurality of performance tests used to compute the aggregated measure). For instance, Commit 1 901 has a performance measure of 2.5 and a standard deviation of 0.1 while Commit 9 909 has a performance measure of 5.5 and a standard deviation of 0.2. In this example, the baseline performance value is 3.0 and lower performance values indicate better performance. Here, Commits 1-3 901-903 have performance measures of 2.5, which are better than or equal to the baseline value of 3.0, and Commits 4-9 have performance measures of 5.5, which are worse than the baseline value of 3.0. Thus, Commits 1-3 901-903 pass the performance test while Commits 4-9 904-909 fail the performance test (e.g., Commits 4-9 have a performance regression).

As mentioned above, the effectiveness measure is formulated as P (shift is at C|B( )=C), which can be reformulated using Bayes' Law, which states:

P(X|Y)=P(Y|X)P(X)/P(Y)

From Bayes' Law, the Effectiveness Measure may be reformulated as:

P(shift is at C|B( )=C)=P(B( )=C|shift is at C)P(shift is at C)/P(B( )=C)

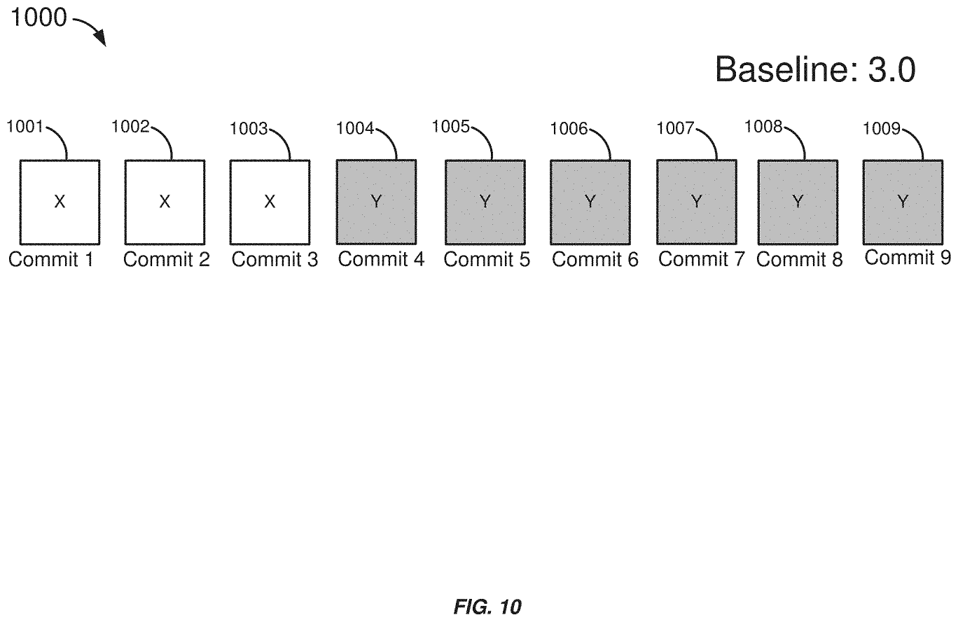

One part of this equitation is P(B( )=C|shift is at C), which is the probability that the bisection gives C as the result given that the shift in distribution occurs at C. That is, Commit C that introduced the performance regression, indicated by the shift in distribution. This probability can be simplified by representing the distributions shown in FIG. 9 as random variables X and Y as further discussed below with respect to FIG. 10.

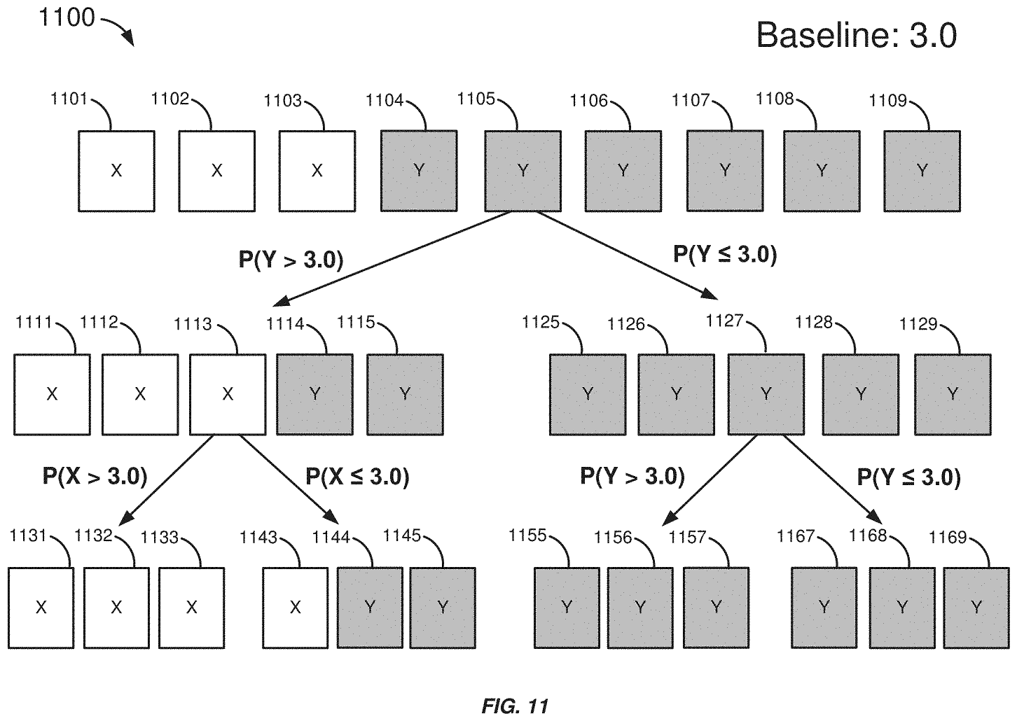

FIG. 10 shows a diagram 1000 modeling software commits for determination of an effectiveness measure that represents the distributions as X and Y, according to an embodiment. The Commits 1-9 1001-1009 in diagram 1000 correspond to the Commits 1-9 901-909 in diagram 900 except that the distributions are represented as random variables X and Y, where X indicates a passing performance measure and Y indicates a failing performance measure. In this example, the baseline is 3.0 as well. Here, a bisect will continue the binary search with the left side (Commits 1-5) if Y is greater than 3.0 and it will continue the binary search with the right side (Commits 5-9) if Y is less than or equal to 3.0. The possible binary search paths are shown in FIG. 11.

FIG. 11 shows a diagram 1100 of a bisection technique that compares the baseline to X and Y, according to an embodiment. In diagram 1100, Commits 1101-1109 correspond to Commits 1001-1009 of FIG. 10, respectively. The bisect will consider the middle commit 1105 having a distribution of Y and continue the binary search with the left side (Commits 1-5) if Y is greater than 3.0 and it will continue the binary search with the right side (Commits 5-9) if Y is less than or equal to 3.0. In this example, we have predetermined that Y is greater than 3.0. However, as shown in the diagram 1100, the bisection will perform the binary search to the left or the right depending on whether the middle commit has a performance measure distribution that is greater than the baseline of 3.0 (left) or greater than or equal to the baseline of 3.0 (right). For instance, if performance measure distribution Y of Commit 1105 is greater than 3.0, the bisection continues with Commits 1-5 1111-1115 and selects the middle Commit 1113 to be tested. If Commit 1113 has a performance measure distribution of X which is greater than 3.0, the bisection will continue to select the middle Commit 1132 of the left side of Commits 1131-1133. If the distribution of X were less than or equal to 3.0, the bisection would continue with the middle Commit 144 of the right side of Commits 143-145.

Referring back to Commit 1105, if the performance measure distribution Y of Commit 1105 is less than or equal to 3.0, the bisection continues with Commits 5-9 1125-1129 and selects the middle Commit 1127 to be tested. If Y of Commit 1127 is greater than 3.0 the bisection continues with Commits 1155-1157. If Y of Commit 1127 is less than or equal to 3.0, the bisection continues with commits 1167-1169.

From diagram 1100, we can see that the distribution shifts at the fourth commit having distribution Y, even though this would not initially be known before performing the bisection. Accordingly, the bisection search paths can be pruned.

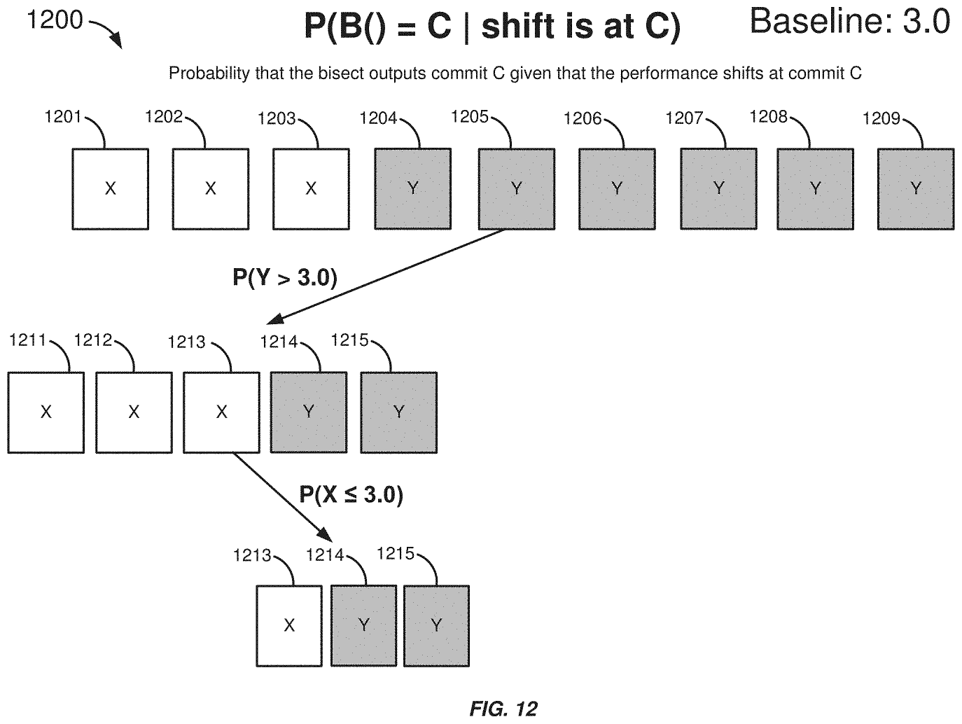

FIG. 12 shows a diagram 1200 of the bisection of FIG. 11 where paths are pruned, according to an embodiment. The commits 1201-1209, 1211-1215, and 1213-1215 correspond to commits 1101-1109, 1111-1115, and 1113-1115 of diagram 1100, respectively. The other paths from diagram 1100 may be pruned out because the goal is to find the probability that bisect outputs the commit C where the distribution shifts. Thus, paths that do not lead to C (the fourth Commit) may be pruned out.

As shown in the previous examples, P(B( )=C|shift is at C) may be computed recursively, given a baseline value, an array of commits, and the commit C at which the distribution shifts. Computing P(Y>=3.0), P(Y<=3.0) may be done using a cumulative distribution function (CDF).

As mentioned above, the effectiveness measure may be formulated as P(shift is at C|B( )=C)=P(B( )=C|shift is at C)P(shift is at C)/P(B( )=C). Another part of this equation is the probability that the shift is at commit C: P(shift is at C). For the P(shift is at C), given no additional information, it can be assumed that the shift can happen anywhere from the second commit onwards, with equal probability. From this, P(shift is at C) can compute it as follows:

P(shift is at C)=1/(number of commits−1)

Since this probability may be frequently computed as part of the recursion, it may help to write it based on the commit indices of the first and last commits (e.g., a and b, respectively), as follows:

P(shift is at C)=1/(b−a), if 2<=C<=b−a+1 P(shift at C)=0, otherwise

Another part of the effectiveness measure equation is the probability that the bisection outputs a result of Commit C (the commit having the shift in distribution), which is formulated as P(B( )=C). Because the shifts are mutually exclusive, this may be reformulated as:

P(B( )=C)=P(B( )=C|shift is at commit 2)P(shift is at commit 2)+P(B( )=C|shift is at commit 3)P(shift is at commit 3)+ . . . +P(B( )=C|shift is at C)P(shift is at C)+ . . . +P(B( )=C|shift is at commit N)P(shift is at commit N)

Each of these portions of this equation may be computed based on the previous equation above.

As shown by the equality above, the effectiveness measure, P(shift is at C|B( )=C), can be computed from the three portions of the right side of the equation. Note that the effectiveness measure is applicable to one commit (e.g., Commit C). It would be advantageous to determine an effectiveness measure that is based on an average of all of the possible commits that introduced the performance regression. This average effectiveness measure over the plurality of commits that possibly introduced the regression may indicate how effective the bisection is expected to be.

Furthermore, note that the calculations above assume a specific baseline value v. The most effective baseline value of a set of baseline values may be determined by recomputing the average effectiveness value for each baseline value in the set. The set of baseline values may be values between the performance measure (e.g., median or mean) of the passing commit and the performance measure (e.g., median or mean) of the failing commit. The values may be selected based on an interval (e.g., 0.1). For example, if the passing performance value is 2.5 and the failing performance value is 5.5, as in the example above, then the set of baseline values to use in determining the most effective baseline value of the set would include 2.6, 2.7, 2.8, and so on up to 5.4. Instead of determining the effectiveness of each baseline value in the set, a binary search may be conducted across the baseline values in order to determine the baseline value having the highest effectiveness measure from among the baseline values in the set.

Thus, an average effectiveness measure given a particular baseline may be computed based on an effectiveness measure for each commit in an array of commits and a most effective baseline value may be determined by computing the average effectiveness for certain baseline values in a set of baseline values (e.g., using a binary search). This technique is advantageous as it enables a software developer to determine the probability that the bisection will be effective (i.e., that the bisection will accurately identify the commit that introduced the performance regression) and it further provides an effective baseline value to use for the bisect. Accordingly, when a performance regression is identified, the software developer can determine whether to spend time and computing resources to perform a bisect, and use other regression localizing techniques if not.

FIG. 13 shows a diagram 1300 of hardware of a special purpose computing system 13010 for implementing systems and methods described herein. The computer system 1310 includes a bus 1305 or other communication mechanism for communicating information, and one or more processors 1301 coupled with bus 1305 for processing information. The computer system 1310 also includes a memory 1302 coupled to bus 1305 for storing information and instructions to be executed by the processor(s) 1301, including information and instructions for performing some of the techniques described above, for example. This memory 1302 may also be used for storing programs executed by processor(s) 1301. Possible implementations of this memory 1302 may be, but are not limited to, random access memory (RAM), read only memory (ROM), or both. A storage device 1303 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 1303 may include source code, binary code, or software files for performing the techniques above, such as the processes described above, for example. Storage device 1303 and memory 1302 are both examples of non-transitory computer readable storage mediums.

The computer system 1301 may be coupled via bus 1305 to a display 1312 for displaying information to a computer user. An input device 1311 such as a keyboard, touchscreen, and/or mouse is coupled to bus 1305 for communicating information and command selections from the user to the processor(s) 1301. The combination of these components allows the user to communicate with the system 13010. In some systems, bus 1305 represents multiple specialized buses, for example.

The computer system 1301 also includes a network interface 1304 coupled with bus 1305. The network interface 1304 may provide two-way data communication between computer system 1310 and a first network 1320. The network interface 1304 may be a wireless or wired connection, for example. The computer system 1310 can send and receive information through the network interface 1304 across the first network 1320, which may be a local area network, an Intranet, a cellular network, or the Internet, for example. In the Internet example, a browser, for example, may access data and features on backend systems that may reside on multiple different hardware servers 1331, 1332, 1333, 1334 across first network 1320, and optionally, a second network 1330. The servers 1331-1334 may be part of a cloud computing environment, for example.

### Additional Embodiments

One embodiment provides a computer system comprising one or more processors and one or more machine-readable medium coupled to the one or more processors. The one or more machine-readable medium storing computer program code comprising sets of instructions. The sets of instructions executable by the one or more processors to compare a performance measure for a later version of software to a performance measure of an earlier version of the software where a difference between the performance measure for the later version and the performance measure for the earlier version indicates a performance regression of the software. The sets of instructions further executable by the one or more processors to determine an effectiveness measure for performing a bisection based on a first probability that a shift in distribution of performance measures of a plurality of versions of the software occurs at a particular version of the software given that a bisection would identify that particular version of the software as having the performance regression. The sets of instructions further executable by the one or more processors to determine a baseline value that maximizes the effectiveness measure by calculating a plurality of effectiveness measures over a set of baseline values. The sets of instructions further executable by the one or more processors to perform the bisection using the most effective baseline value if the effectiveness measure is above a threshold.

In some embodiments of the computer system, the computer program code further comprises sets of instructions executable by the one or more processors to measure performance of an operation of the software in a plurality of tests and determine the second performance measure by aggregating the performance of the operation in the plurality of tests.

In some embodiments of the computer system, the determination of the baseline value that maximizes the effectiveness measure includes conducting a binary search on a set of possible baselines between the first performance measure and the second performance measure, values of possible baselines in the set of possible baselines determined based on an increment value from a value of the first performance measure or the second performance measure.

In some embodiments of the computer system, the computer program code further comprises sets of instructions executable by the one or more processors to determine a second probability that the bisection would identify the particular commit as having the performance regression given that the shift in distribution of performance measures of the plurality of versions of the software occurs at the particular version of the software, where the determination of the first probability is based on the second probability.

In some embodiments of the computer system, the computer program code further comprises sets of instructions executable by the one or more processors to determine a third probability that the shift in distribution of performance measures of the plurality of versions of the software occurs at the particular version of the software based on a number of the plurality of versions of the software, where the determination of the first probability is based on the third probability.

In some embodiments of the computer system, the computer program code further comprises sets of instructions executable by the one or more processors to determine a fourth probability that the bisection would identify the particular commit as having the performance regression, where the determination of the first probability is based on the fourth probability.

In some embodiments of the computer system, the set of baseline values includes values between the performance measure of the earlier version of the software and the performance measure for the later version of software.

Another embodiment provides one or more non-transitory computer-readable medium storing computer program code. The computer program code comprises sets of instructions to compare a performance measure for a later version of software to a performance measure of an earlier version of the software where a difference between the performance measure for the later version and the performance measure for the earlier version indicating a performance regression of the software. The computer program code further comprises sets of instructions to determine an effectiveness measure for performing a bisection based on a first probability that a shift in distribution of performance measures of a plurality of versions of the software occurs at a particular version of the software given that a bisection would identify that particular version of the software as having the performance regression. The computer program code comprises sets of instructions to determine a baseline value that maximizes the effectiveness measure by calculating a plurality of effectiveness measures over a set of baseline values. The computer program code comprises sets of instructions to perform the bisection using the most effective baseline value if the effectiveness measure is above a threshold.

In some embodiments of the non-transitory computer-readable medium, the computer program code further comprises sets of instructions to measure performance of an operation of the software in a plurality of tests and determine the second performance measure by aggregating the performance of the operation in the plurality of tests.

In some embodiments of the non-transitory computer-readable medium, the determination of the baseline value that maximizes the effectiveness measure includes conducting a binary search on a set of possible baselines between the first performance measure and the second performance measure, where values of possible baselines in the set of possible baselines determined based on an increment value from a value of the first performance measure or the second performance measure.

In some embodiments of the non-transitory computer-readable medium, the computer program code further comprises sets of instructions to determine a second probability that the bisection would identify the particular commit as having the performance regression given that the shift in distribution of performance measures of the plurality of versions of the software occurs at the particular version of the software, where the determination of the first probability is based on the second probability.

In some embodiments of the non-transitory computer-readable medium, the computer program code further comprises sets of instructions to determine a third probability that the shift in distribution of performance measures of the plurality of versions of the software occurs at the particular version of the software based on a number of the plurality of versions of the software, where the determination of the first probability is based on the third probability.

In some embodiments of the non-transitory computer-readable medium, the computer program code further comprises sets of instructions to determine a fourth probability that the bisection would identify the particular commit as having the performance regression, where the determination of the first probability is based on the fourth probability.

In some embodiments of the non-transitory computer-readable medium, the set of baseline values includes values between the performance measure of the earlier version of the software and the performance measure for the later version of software.

Another embodiment provides a computer-implemented method. The method includes comparing a performance measure for a later version of software to a performance measure of an earlier version of the software where a difference between the performance measure for the later version and the performance measure for the earlier version indicating a performance regression of the software. The method further includes determining an effectiveness measure for performing a bisection based on a first probability that a shift in distribution of performance measures of a plurality of versions of the software occurs at a particular version of the software given that a bisection would identify that particular version of the software as having the performance regression. The method further includes determining a baseline value that maximizes the effectiveness measure by calculating a plurality of effectiveness measures over a set of baseline values. The method further includes performing the bisection using the most effective baseline value if the effectiveness measure is above a threshold.

In some embodiments of the computer-implemented method, the method further comprises measuring performance of an operation of the software in a plurality of tests and determining the second performance measure by aggregating the performance of the operation in the plurality of tests.

In some embodiments of the computer-implemented method, the determination of the baseline value that maximizes the effectiveness measure includes conducting a binary search on a set of possible baselines between the first performance measure and the second performance measure, where values of possible baselines in the set of possible baselines are determined based on an increment value from a value of the first performance measure or the second performance measure.

In some embodiments of the computer-implemented method, the method further comprises determining a second probability that the bisection would identify the particular commit as having the performance regression given that the shift in distribution of performance measures of the plurality of versions of the software occurs at the particular version of the software, where the determination of the first probability is based on the second probability.

In some embodiments of the computer-implemented method, the method further comprises determining a third probability that the shift in distribution of performance measures of the plurality of versions of the software occurs at the particular version of the software based on a number of the plurality of versions of the software, where the determination of the first probability is based on the third probability.

In some embodiments of the computer-implemented method, the method further comprises determining a fourth probability that the bisection would identify the particular commit as having the performance regression, where the determination of the first probability is based on the fourth probability.

Advantages

As mentioned above, performing a bisection for software performance regression may be time-consuming because numerous performance tests may need to be conducted for a single version of the software (i.e., a single commit) to achieve statistical significance. Furthermore, numerous versions of the software may need to be tested when performing the bisection. Selection of the baseline used in the performance measure comparison may be important to the accuracy of the bisection since the performance may vary due to other external factors beyond the software code (e.g., network performance, user input delays, available processing and memory resources, the response times of other computer systems, etc.). Given the possible variance in performance numbers, the bisection for a performance regression may be heuristical. Due to its probabilistic nature, it would be advantageous to quantify the likelihood that bisection outputs the correct commit and to determine the conditions under which this likelihood is high. Practitioners may then use these findings to determine whether bisection is a suitable solution when localizing specific performance regressions, and if so, determine the parameters (e.g., baseline) with which to configure the bisection.

To help solve these issues, an effectiveness measure is formulated which can be used to quantify the probability of a successful bisection. Therefore, if a bisection would be less likely to succeed (e.g., based on a threshold value) then the bisection may not be performed and other regression localization techniques may be used instead. If a bisection has a higher probability of success (e.g., based on the threshold value), then the bisection may be performed. Furthermore, the most effective baseline value may be determined using the techniques above such that the accuracy of the bisection is increased. That is, the accuracy in determining the commit that actually caused the software regression. Accordingly, computing and processing resources spent in localizing the performance regression may be reduced.

Results of Empirical Study

The inventor conducted an empirical study of over 300 bug reports from 17 popular GitHub projects, with each bug report describing a software performance regression. The goal of the study was to understand the most important properties that lead to an effective bisection and to analyze how well these properties translate in real-world settings. A short summary of the study and its findings are presented below.

The study used one-at-a-time (OAT) sensitivity analysis to determine the impact of each individual contributing property. The analysis entailed choosing nominal values for each contributing property. When analyzing a particular contributing property, the value for that contributing property is varied, and the other contributing properties are set to their nominal values. For the commit range length, a nominal value of 100 was used, as this value was well within the range of commit range lengths often encountered in practice and because computing the effectiveness may be computationally intensive for larger commit range lengths.

For the distributions, the nominal value for the mean was randomly chosen to be between 1000 and 10000, and the nominal value for the standard deviation was randomly chosen between 100 and 1000. These values are based on the inventor's experience in trying to localize response time regressions, in units of milliseconds. Further, randomly choosing the distribution parameters from a range of values instead of fixing them simulates what one may encounter in practice, where the distribution shapes are varied. To increase generalizability, multiple pairs of distributions were considered in the analysis. A nominal value for the transition index was not set for the analysis, as the study was on average effectiveness, where this property is abstracted out. In addition, a nominal value was not set for the baseline because the study considers the baseline that produces the maximum effectiveness value. The set of baseline values considered when trying to ascertain this maximum ranged from the mean of distribution X to the mean of distribution Y, in intervals of 10.

These software applications studied were taken from GitHub repositories, omitting applications that did not contain an “Issues” tab in GitHub, as well as any applications that did not have any performance regressions reported. A maximum of 30 bug reports were collected for each application, and the collection was halted once the total exceeded 300 bug reports. The number of bug reports was capped, as analyzing each one required significant effort, with each bug report requiring 10-20 minutes to be analyzed on average; thus, a balance between the effort involved and the number of samples analyzed needed to be made. Following this process, a total of 310 bug reports were collected from 17 applications. In most cases, the search term used to find the bug reports was performance regression is:closed. However, in cases where this search term did not provide too many results, it was altered either by relaxing some of the keywords or including labels or tags as part of the search. Furthermore, only closed bug reports that are acknowledged by the developers as a performance regression are considered. This acknowledgement was either explicitly made in the comments or implicitly made by the presence of a fix or a recommended resolution that still implies a regression (e.g., fixed in a later version, accepting the performance hit, etc.).

The findings of the study are as follows:

Finding 1: The choice of baseline may have a significant impact on the effectiveness of a bisection.

Finding 2: The mean of the distribution at the good commit may not be a good baseline to use, and may lead to the least effective bisections.

Finding 3: Certain performance regression bug reports may not contain sufficient information to compute an optimal baseline.

Finding 4: Certain performance regression bug reports provide full version information. However, some of these bug reports do not provide complete distribution information (e.g., missing standard deviations).

Finding 5: The maximum effectiveness increases as the distance between the pre-regression mean and the post-regression mean increases.

Finding 6: The maximum effectiveness decreases as the standard deviation of any of the distributions increases, with the maximum effectiveness being slightly more sensitive to the pre-regression standard deviation.

Finding 7: The overlapping coefficient has a significant negative correlation with the maximum effectiveness, and can be used as a rough predictor of the effectiveness measure.

Finding 8: Distribution pairs in reported performance regressions tend to have small overlap, making them more amenable to bisection.

Finding 9: The maximum effectiveness decreases as the commit range length increases, at a rate that gets slower with longer lengths.

Finding 10: In cases where full version information is provided, some reporters of performance regressions provide the version number for the commit range.

Finding 11: The commit range length tends to be shorter when hashes are provided compared to when version numbers are provided.

Finding 12: The effectiveness of a bisection varies with different transition indices.

Finding 13: Some reported performance regressions have low sensitivity to the transition index, but a significant number are still sensitive to this parameter.

Finding 14: Bisection is effective in most reported performance regressions, although the effectiveness can still be quite low for some.

Finding 1 implies the need to compute an optimal baseline when doing bisection for a performance regression. Finding 2 provides guidance on the choice of baseline, and the optimal baseline can be determined more precisely by implementing the effectiveness measure. One practical consideration is the time complexity of the effectiveness measure calculation. A bottleneck of this calculation is the computation of the output probability. Given n commits, computing this value requires iterating over all but one of the commits, with each iteration taking O(log n). This, the output probability takes O(n log n) to compute. Based on the definition of Average Effectiveness, this means the average effectiveness computation has a time complexity of O(n² log n). However, the simplified version of the average effectiveness equation may compute the likelihood n−1 times, which reduces the complexity to O(n log n). In order to find the optimal baseline, this computation must be done over several baseline values (e.g., between the two means). If the number of possible baselines considered between the two means (based on some increment) is m, a linear search for the optimal baseline will therefore take O(mnlog n). However, since the effectiveness may increase towards a peak and then decreases, a binary search may be carried out, which may reduce the time complexity to O(n log(m+n)). Accordingly, this binary search approach may be used to compute the effectiveness measure and corresponding baseline.

The results from the above study and analysis show that the effectiveness of a bisection on performance regressions is impacted by the choice of the baseline value and the characteristics of the probabilistic distributions describing the commit without the performance regression and the commit with the performance regression. The study on the bug reports also indicates that certain performance regressions reported in real-world applications may not contain sufficient information to make a proper baseline assessment. To a lesser degree, the length of the commit range is also shown to impact the effectiveness. However, based on the empirical study, bug reports tend to provide version numbers for the commit range instead of hashes, and these version numbers typically correspond to longer commit ranges as the results also show. The study also reveals that the effectiveness can be sensitive to the transition index. That is, the suspected location of the bug-introducing commit, which implies that it would be useful to measure the effectiveness of a bisection both before and after it executes.

What is claimed is:

1. A computer system, comprising:
one or more processors; and
one or more machine-readable medium coupled to the one or more processors and storing computer program code comprising sets of instructions executable by the one or more processors to:
compare a performance measure for a later version of software to a performance measure of an earlier version of the software, a difference between the performance measure for the later version and the performance measure for the earlier version indicating a performance regression of the software;
determine an effectiveness measure for performing a bisection based on a first probability that a shift in distribution of performance measures of a plurality of versions of the software occurs at a particular version of the software given that a bisection would identify that particular version of the software as having the performance regression;
determine a baseline value that maximizes the effectiveness measure by calculating a plurality of effectiveness measures over a set of baseline values; and
perform the bisection using the most effective baseline value if the effectiveness measure is above a threshold.

2. The computer system of claim 1, wherein the computer program code further comprises sets of instructions executable by the one or more processors to:
measure performance of an operation of the software in a plurality of tests; and
determine the second performance measure by aggregating the performance of the operation in the plurality of tests.

3. The computer system of claim 1, wherein the determination of the baseline value that maximizes the effectiveness measure includes conducting a binary search on a set of possible baselines between the first performance measure and the second performance measure, values of possible baselines in the set of possible baselines determined based on an increment value from a value of the first performance measure or the second performance measure.

4. The computer system of claim 1, wherein the computer program code further comprises sets of instructions executable by the one or more processors to:
determine a second probability that the bisection would identify the particular commit as having the performance regression given that the shift in distribution of performance measures of the plurality of versions of the software occurs at the particular version of the software, wherein the determination of the first probability is based on the second probability.

5. The computer system of claim 1, wherein the computer program code further comprises sets of instructions executable by the one or more processors to:
determine a third probability that the shift in distribution of performance measures of the plurality of versions of the software occurs at the particular version of the software based on a number of the plurality of versions of the software, wherein the determination of the first probability is based on the third probability.

6. The computer system of claim 1, wherein the computer program code further comprises sets of instructions executable by the one or more processors to:
determine a fourth probability that the bisection would identify the particular commit as having the performance regression, wherein the determination of the first probability is based on the fourth probability.

7. The computer system of claim 1, wherein the set of baseline values includes values between the performance measure of the earlier version of the software and the performance measure for the later version of software.

8. One or more non-transitory computer-readable medium storing computer program code comprising sets of instructions to:
compare a performance measure for a later version of software to a performance measure of an earlier version of the software, a difference between the performance measure for the later version and the performance measure for the earlier version indicating a performance regression of the software;
determine an effectiveness measure for performing a bisection based on a first probability that a shift in distribution of performance measures of a plurality of versions of the software occurs at a particular version of the software given that a bisection would identify that particular version of the software as having the performance regression;
determine a baseline value that maximizes the effectiveness measure by calculating a plurality of effectiveness measures over a set of baseline values; and
perform the bisection using the most effective baseline value if the effectiveness measure is above a threshold.

9. The non-transitory computer-readable medium of claim 8, wherein the computer program code further comprises sets of instructions to:
measure performance of an operation of the software in a plurality of tests; and
determine the second performance measure by aggregating the performance of the operation in the plurality of tests.

10. The non-transitory computer-readable medium of claim 8, wherein the determination of the baseline value that maximizes the effectiveness measure includes conducting a binary search on a set of possible baselines between the first performance measure and the second performance measure, values of possible baselines in the set of possible baselines determined based on an increment value from a value of the first performance measure or the second performance measure.

11. The non-transitory computer-readable medium of claim 8, wherein the computer program code further comprises sets of instructions to:
determine a second probability that the bisection would identify the particular commit as having the performance regression given that the shift in distribution of performance measures of the plurality of versions of the software occurs at the particular version of the software, wherein the determination of the first probability is based on the second probability.

12. The non-transitory computer-readable medium of claim 8, wherein the computer program code further comprises sets of instructions to:
determine a third probability that the shift in distribution of performance measures of the plurality of versions of the software occurs at the particular version of the software based on a number of the plurality of versions of the software, wherein the determination of the first probability is based on the third probability.

13. The non-transitory computer-readable medium of claim 8, wherein the computer program code further comprises sets of instructions to:
determine a fourth probability that the bisection would identify the particular commit as having the performance regression, wherein the determination of the first probability is based on the fourth probability.

14. The non-transitory computer-readable medium of claim 8, wherein the set of baseline values includes values between the performance measure of the earlier version of the software and the performance measure for the later version of software.

15. A computer-implemented method, comprising:
comparing a performance measure for a later version of software to a performance measure of an earlier version of the software, a difference between the performance measure for the later version and the performance measure for the earlier version indicating a performance regression of the software;
determining an effectiveness measure for performing a bisection based on a first probability that a shift in distribution of performance measures of a plurality of versions of the software occurs at a particular version of the software given that a bisection would identify that particular version of the software as having the performance regression;
determining a baseline value that maximizes the effectiveness measure by calculating a plurality of effectiveness measures over a set of baseline values; and
performing the bisection using the most effective baseline value if the effectiveness measure is above a threshold.

16. The computer-implemented method of claim 15, further comprising:
measuring performance of an operation of the software in a plurality of tests; and
determining the second performance measure by aggregating the performance of the operation in the plurality of tests.

17. The computer-implemented method of claim 16, wherein the determination of the baseline value that maximizes the effectiveness measure includes conducting a binary search on a set of possible baselines between the first performance measure and the second performance measure, values of possible baselines in the set of possible baselines determined based on an increment value from a value of the first performance measure or the second performance measure.

18. The computer-implemented method of claim 15, further comprising:
determining a second probability that the bisection would identify the particular commit as having the performance regression given that the shift in distribution of performance measures of the plurality of versions of the software occurs at the particular version of the software, wherein the determination of the first probability is based on the second probability.

19. The computer-implemented method of claim 15, further comprising:
determining a third probability that the shift in distribution of performance measures of the plurality of versions of the software occurs at the particular version of the software based on a number of the plurality of versions of the software, wherein the determination of the first probability is based on the third probability.

20. The computer-implemented method of claim 15, further comprising:
determining a fourth probability that the bisection would identify the particular commit as having the performance regression, wherein the determination of the first probability is based on the fourth probability.
